(19) United States
(12) Patent Application Publication
(10) Pub. No.: US 2022/0143965 A1
(43) Pub. Date: May 12, 2022

(54) SYSTEM FOR MANUFACTURING COMPOSITE STRUCTURED LAMINATE

(71) Applicant: HORTON WORLD SOLUTIONS, LLC, SOUTHLAKE, TX (US)

(72) Inventor: FRED ARTHUR SIMMONS, SOUTHLAKE, TX (US)

(21) Appl. No.: 17/450,669

(22) Filed: Oct. 12, 2021

Related U.S. Application Data
(60) Provisional application No. 63/090,564, filed on Oct. 12, 2020.

(51) Int. Cl. B32B 37/00; B32B 37/06; B32B 37/08; B32B 37/10; B32B 38/00; B32B 38/18

(52) U.S. Cl. CPC B32B 37/0053; B32B 37/06; B32B 38/18; B32B 37/10; B32B 38/0004; B32B 37/08

(57) ABSTRACT

Systems for manufacturing a composite structural laminate comprising a conveyor element, a plurality of heating elements, and a plurality of cooling elements. The system may further incorporate a series of cutting elements that distribute constituent laminate elements along the conveyor element. The system provides heating and cooling of the constituent laminate elements which results in improved strength for the resulting laminate.

### BACKGROUND AND SUMMARY OF THE INVENTION

Structural Insulated Panels (“SIP”) are conventionally manufactured with plywood/oriented strand board (“OSB”) adhered to either a foam or honeycomb core. These SIPs are used in the housing industry and in some commercial buildings though significant problems arise from such use.

For example, even celebrities reported having problems with property in New Orleans—specifically noting houses built in the 9th Ward as being filled with mold and mildew. The houses were designed out of wood SIP panels, but the OSB wood sheathing was not adequately protected. Moisture was absorbed by the wood rendering the housing uninhabitable in their present state.

Composite Sandwich Panels are custom fabricated and hand laid in the aircraft and wind turbine industries. These kinds of panels are very expensive—relying on hand-placing the fibers and utilizing fiberglass, and in some cases aluminum, skins.

These products, again typically used in aircraft and satellites, are too expensive and too slow to produce for practical adoption in the housing industry.

Composite laminates are used in the automobile industry to make head liners. They use polypropylene and fiberglass. Some manufacturers use ½-inch long fibers and others use 2-inch long fibers. The weight per square foot of such laminates is around 0.1 pounds.

Glass Mat Technology (GMT) was developed by Georgia Tech to create a way of re-using plastic waste products. The construction industry can use these re-cycled plastics in large volumes.

GMT uses composite laminates to adhere to foam or honeycomb to produce small lightweight panels for rooftop installations.

There are numerous woven and non-woven fiberglass “sheathing” that are solidified in other processes to make a structural laminate. These have 0 degree fibers that run parallel to the machine direction and 90 degree fibers that run across the width of the machine. The ability to have strength in the 45 and −45 degree direction incurs additional costs and slows down the process.

In view of these conventionally known materials and the shortcomings thereof, it is an object of the present disclosure to provide a system for manufacturing a composite laminate that is cost-efficient and time-efficient to create while also maintaining sufficient protection and quality of the manufactured laminate to make possible its use in the housing industry.

The systems as embodied in the present disclosure are designed to employ rollers, heaters, and coolers to efficiently create composite laminates for use in panels suitable for construction of housing.

### BRIEF DESCRIPTION OF THE DRAWINGS

The following figures are included to illustrate certain aspects of the present disclosure, and should not be viewed as exclusive embodiments. These subject matter disclosed is capable of considerable modification, alteration, and equivalents in form and function, as will occur to one having ordinary skill in the art and the benefit of this disclosure.

FIG. 1 depicts a side perspective view of a laminate manufacturing system in accordance with various embodiments.

FIG. 2 depicts a side and top view of a laminate manufacturing system in accordance with various embodiments

FIG. 3 depicts a perspective view of a laminate manufacturing system in accordance with various embodiments.

FIG. 4 depicts a side view of a lower unwind in accordance with various embodiments.

FIG. 5 depicts a front view of a lower unwind in accordance with various embodiments.

FIG. 6 depicts a perspective view of a lower unwind in accordance with various embodiments.

FIG. 7 depicts views of a chopper unit in accordance with various embodiments.

FIG. 8 depicts an exploded view of a chopper unit in accordance with various embodiments.

FIG. 9 depicts views of a powder coating unit in accordance with various embodiments.

FIG. 10 depicts a perspective view of a powder coating unit in accordance with various embodiments.

FIG. 11 depicts views of a catwalk in accordance with various embodiments.

FIG. 12 depicts a side perspective view of an upper unwind in accordance with various embodiments.

FIG. 13 depicts a side perspective view of an upper unwind in accordance with various embodiments.

FIG. 14 depicts a top perspective view of heater sections in accordance with various embodiments.

FIG. 15 depicts a side view of heater sections in accordance with various embodiments.

FIG. 16 depicts a top perspective view of a heater frame in accordance with various embodiments.

FIG. 17 depicts a top view of a heater frame in accordance with various embodiments.

FIG. 18 depicts a side view of a heater frame in accordance with various embodiments.

FIG. 19 depicts views of a heater assembly in accordance with various embodiments.

FIG. 20 depicts views of an upper heating bank assembly in accordance with various embodiments.

FIG. 21 depicts a side view of cooling assemblies in accordance with various embodiments.

FIG. 22 depicts a top perspective view of an upped cooling bank assembly in accordance with various embodiments.

FIG. 23 depicts an exploded view of a cooling buck assembly in accordance with various embodiments.

FIG. 24 depicts a top perspective view of cooling manifolds in accordance with various embodiments.

FIG. 25 depicts views of a main drive system in accordance with various embodiments.

FIG. 26 depicts a diagrammatic view of a top and bottom drive belt threading in accordance with various embodiments.

FIG. 27 depicts a perspective view of an upper tracking assembly in accordance with various embodiments.

FIG. 28 depicts a perspective view of a lower tracking assembly in accordance with various embodiments.

FIG. 29 depicts a perspective view of a lower belt takeup in accordance with various embodiments.

FIG. 30 depicts a perspective view of an upper belt takeup in accordance with various embodiments.

FIG. 31 depicts a perspective view of a nip roller assembly in accordance with various embodiments.

FIG. 32 depicts a side view of a nip roller assembly in accordance with various embodiments.

FIG. 33 depicts a perspective view of a nip roller and trimming unit assembly in accordance with various embodiments.

FIG. 34 depicts views of a trimming unit in accordance with various embodiments.

FIG. 35 depicts views of a trimming unit control panel in accordance with various embodiments.

FIG. 36 depicts a front perspective view of a nip roller and length controller assembly in accordance with various embodiments.

FIG. 37 depicts a front view of roller pressure switches in accordance with various embodiments.

FIG. 38 depicts a perspective view of a main control unit in accordance with various embodiments.

FIG. 39 depicts a perspective view of nip roller and length controller assembly control unit in accordance with various embodiments.

FIG. 40 depicts an exemplary user interface of a main control unit in accordance with various embodiments.

FIG. 41 depicts an exemplary user interface of a main control unit in accordance with various embodiments.

FIG. 42 depicts an exemplary user interface of a main control unit in accordance with various embodiments.

FIG. 43 depicts an exemplary heater zone map in accordance with various embodiments.

FIG. 44 depicts an exemplary user interface of a main control unit in accordance with various embodiments.

FIG. 45 depicts an exemplary user interface of a main control unit in accordance with various embodiments.

FIG. 46 depicts an exemplary user interface of a main control unit in accordance with various embodiments.

FIG. 47 depicts a front view of a front panel of a length controller control unit in accordance with various embodiments.

FIG. 48 depicts an exemplary user interface of a nip roller and length controller assembly control unit in accordance with various embodiments.

FIG. 49 depicts an exemplary user interface of a nip roller and length controller assembly control unit in accordance with various embodiments.

FIG. 50 depicts an exemplary user interface of a nip roller and length controller assembly control unit in accordance with various embodiments.

FIG. 51 depicts an exemplary heating zone electrical schematic in accordance with various embodiments.

FIG. 52 depicts an exemplary main drive belt electrical schematic in accordance with various embodiments.

FIG. 53 depicts an exemplary trimming unit electrical schematic in accordance with various embodiments.

FIG. 54 depicts an exemplary chopper unit electrical schematic in accordance with various embodiments.

FIG. 55 depicts a diagrammatic view of a laminate manufacturing system in accordance with various embodiments.

FIG. 56 depicts a perspective view of an exemplary chiller in accordance with various embodiments.

FIG. 57 depicts a perspective view of an exemplary length controller unit in accordance with various embodiments.

FIG. 58 depicts a perspective view of a laminate manufacturing system accordance with various embodiments.

### DETAILED DESCRIPTION OF EMBODIMENTS OF THE PRESENT DISCLOSURE

The present disclosure relates generally to a system for manufacturing a composite structural laminate. For ease of illustration the following description may reference one or more embodiments of such a system.

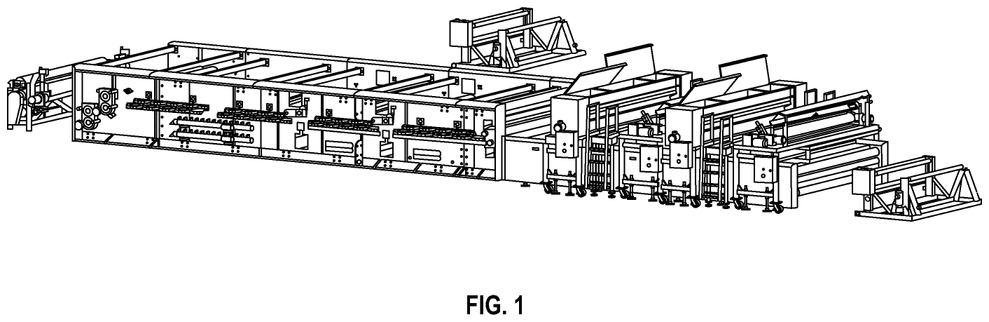

A system according to various embodiments of this disclosure, as depicted in FIG. 1, may comprise the following major components (listed below as they appear in FIG. 1 from right to left):
Lower Unwind Unit
Chopper 1
Catwalk 1
Powder Coater 1
Chopper 2
Catwalk 2
Powder Coater 2
Upper Unwind Unit
Heater Section 1 & 2
Heater Frames & Adjustment
Heater Channels—Assembly & Mounting
Cooling Section 1 & 2
Cooling Frames & Adjustment
Cooling Channels Assembly & Mounting
Cooling Manifolds & Connections
Main Drive & Tracking
Main Drive Motors
Main Drive Rolls
Top & Bottom Belts
Top & Bottom Belt Tracking System
Top & Bottom Belt Take-Up System Internal
Nip Rolls 1 & 2
Nip Roll & Edge Trim for Width Control
Nip Roll for Shear Feed & Length Control
Electrical Control Cabinet
Operator Control Station

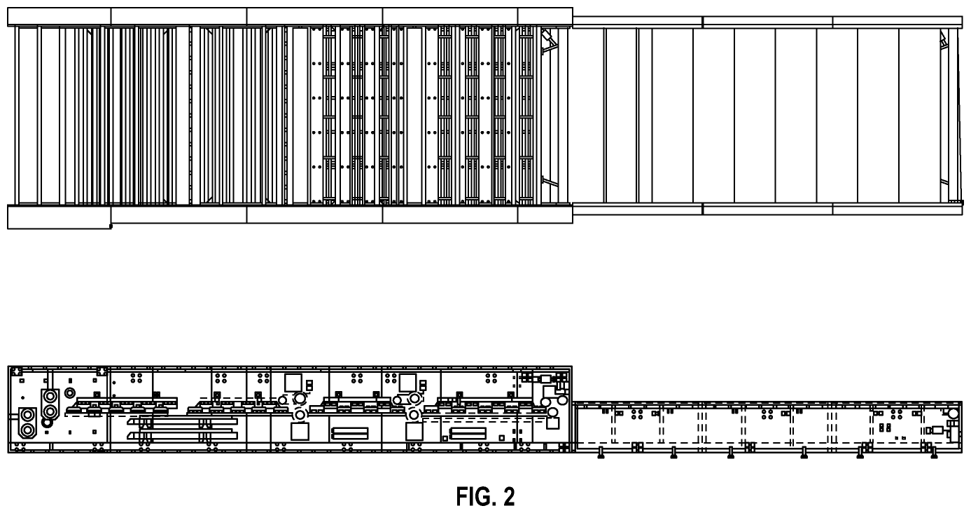

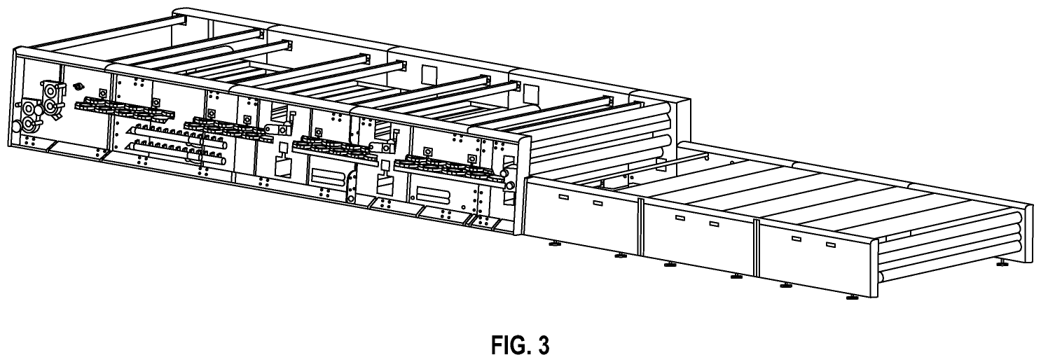

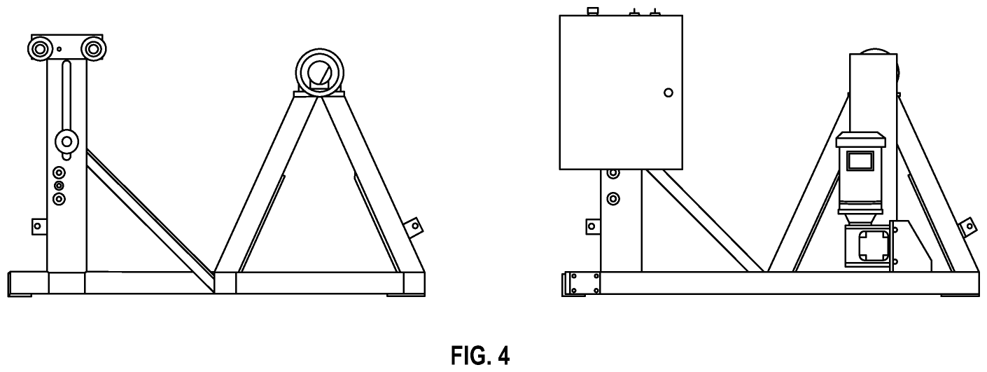

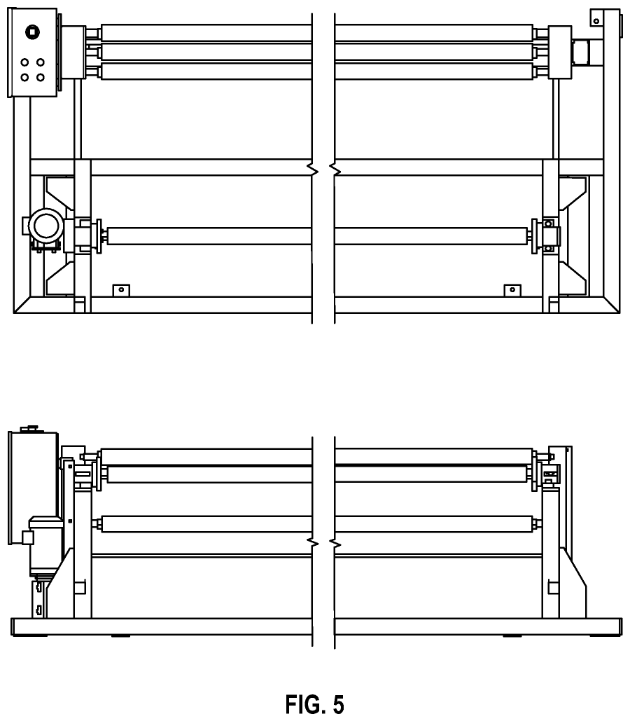

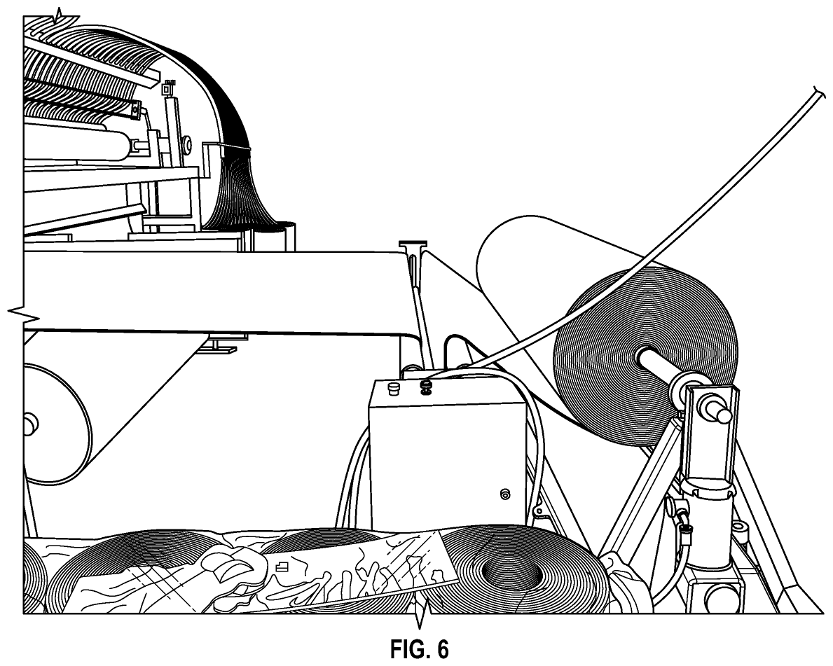

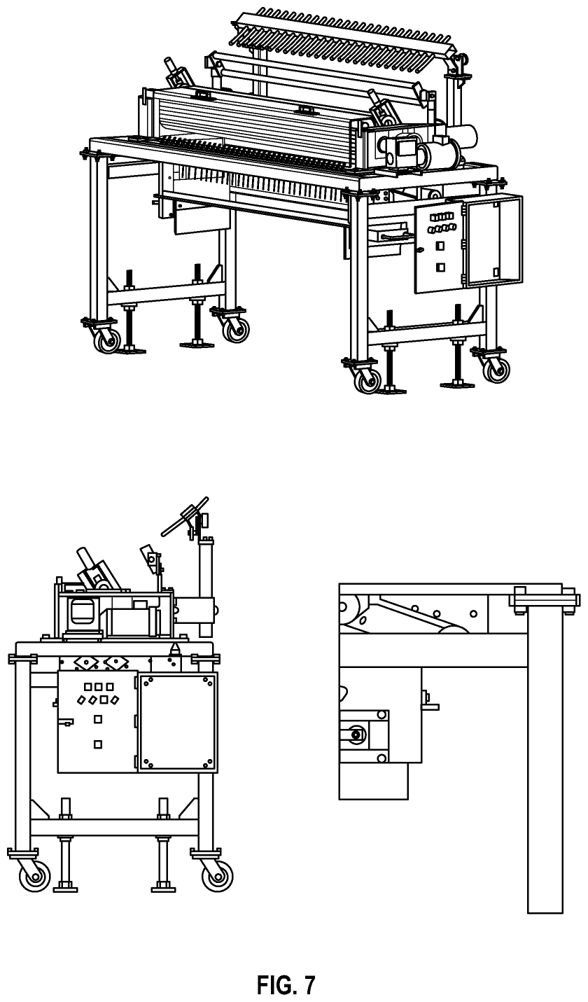

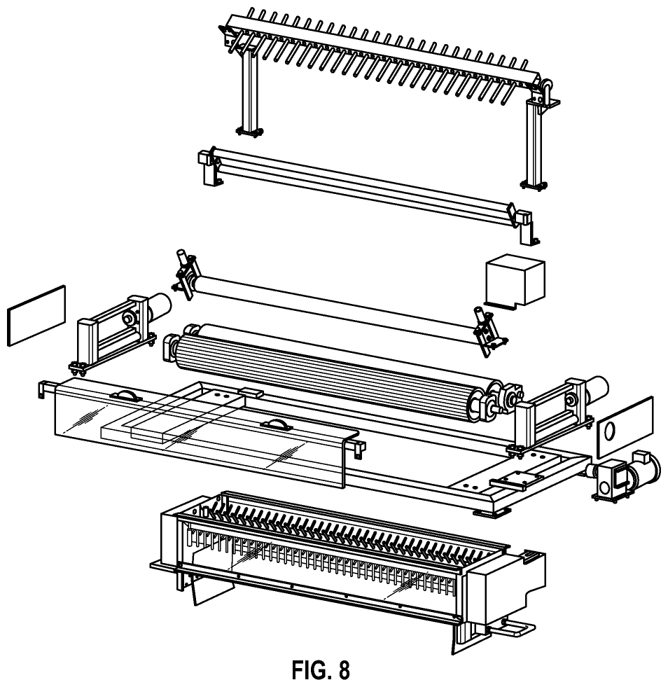

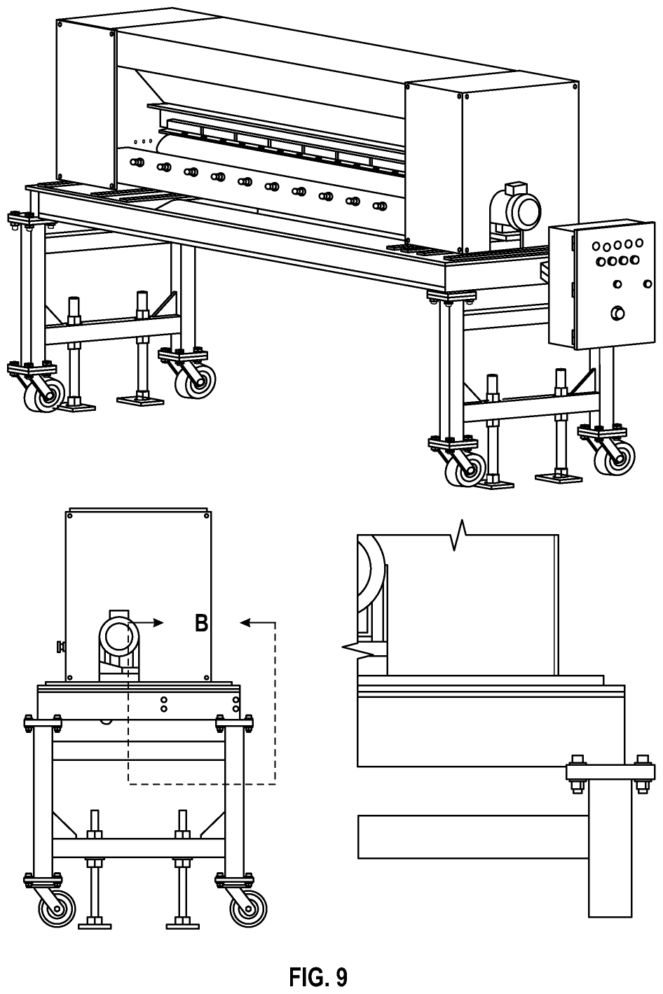

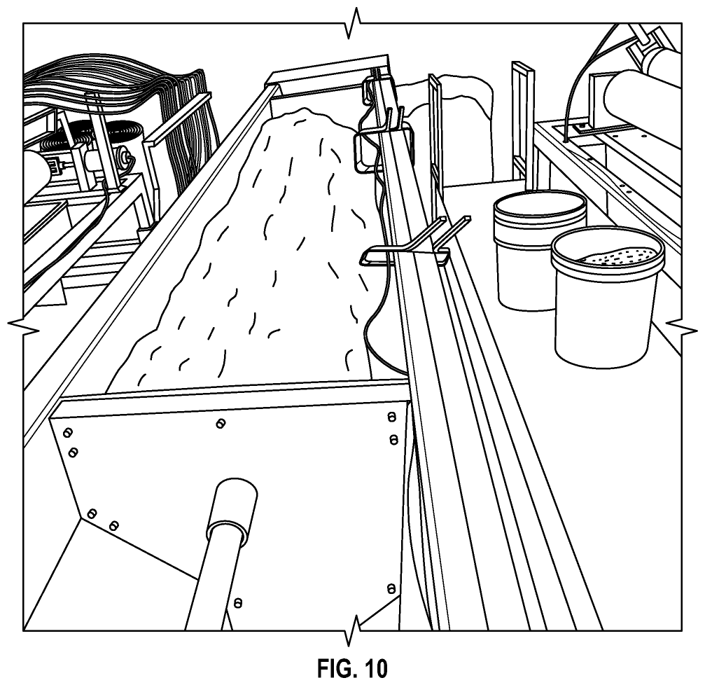

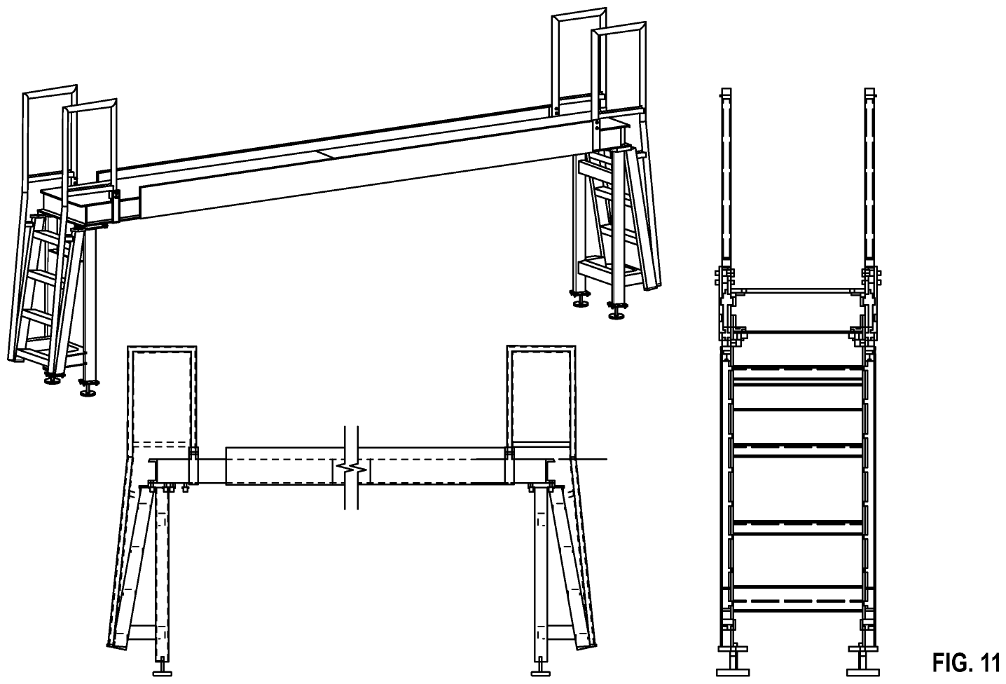

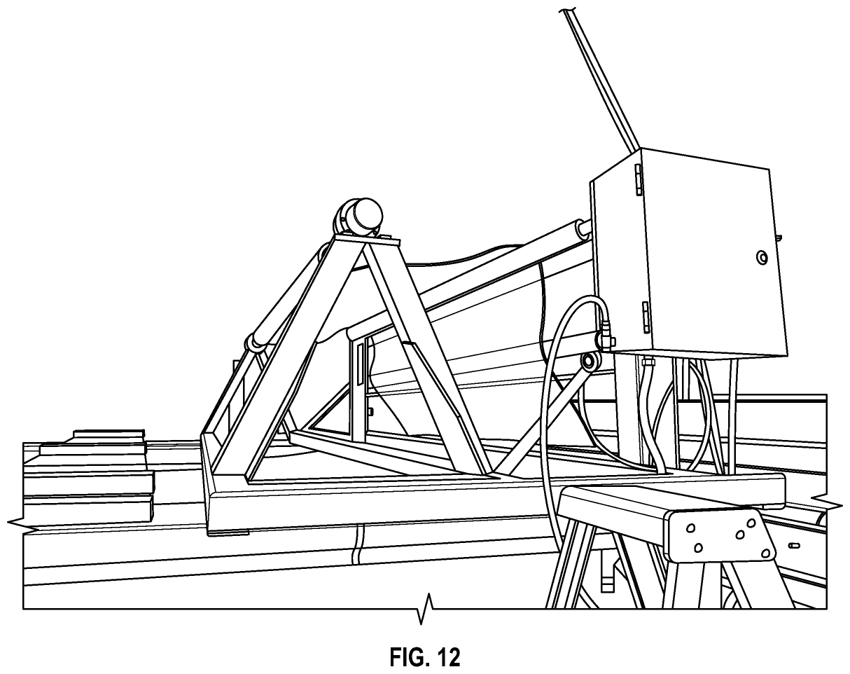

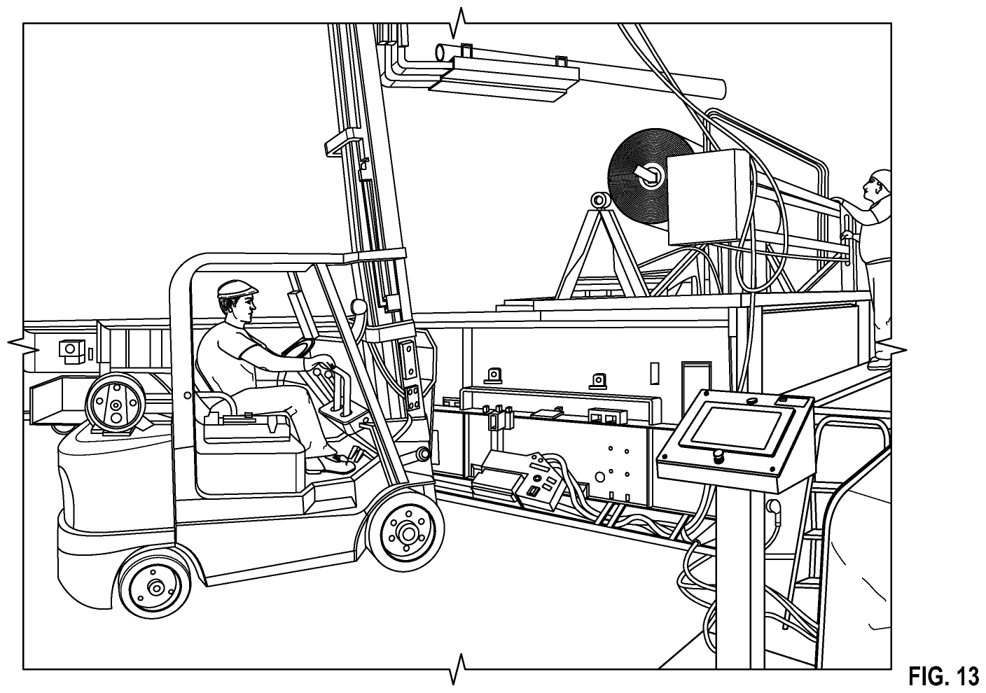

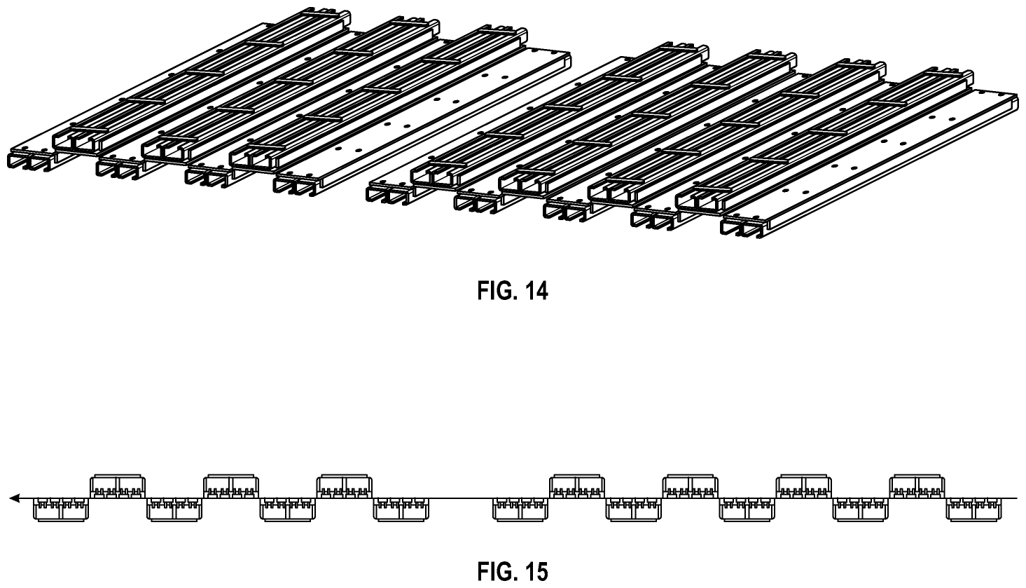

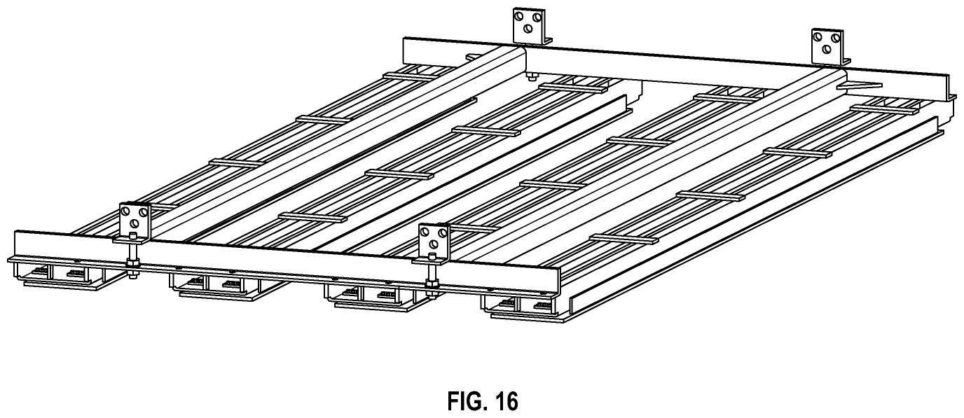

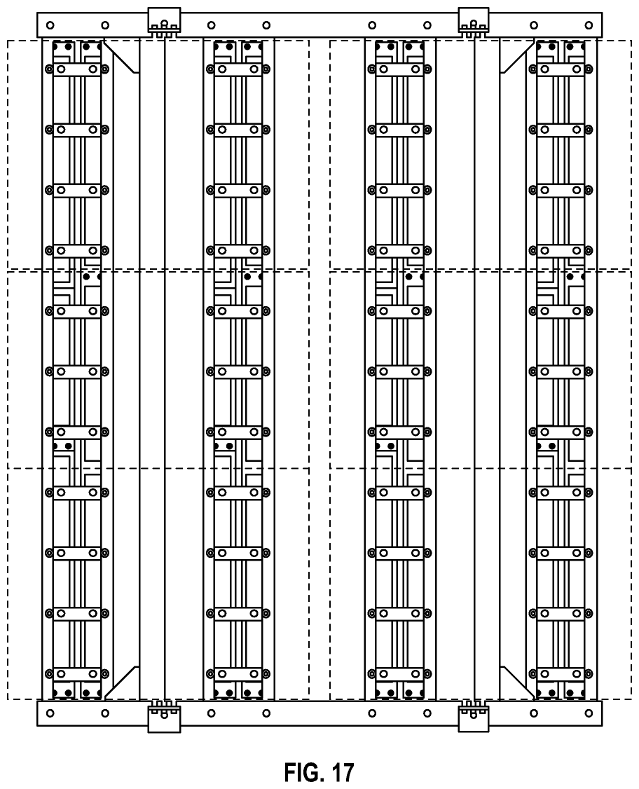

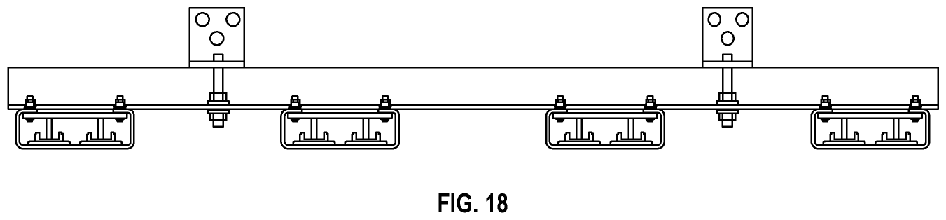

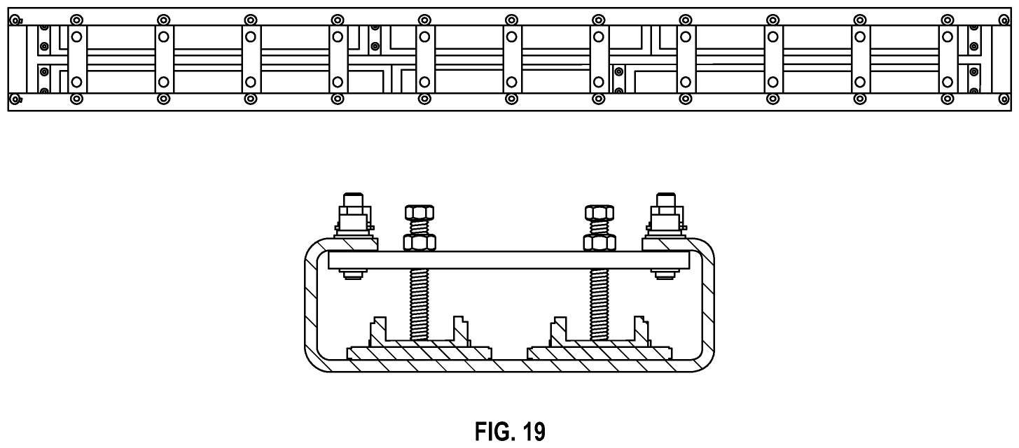

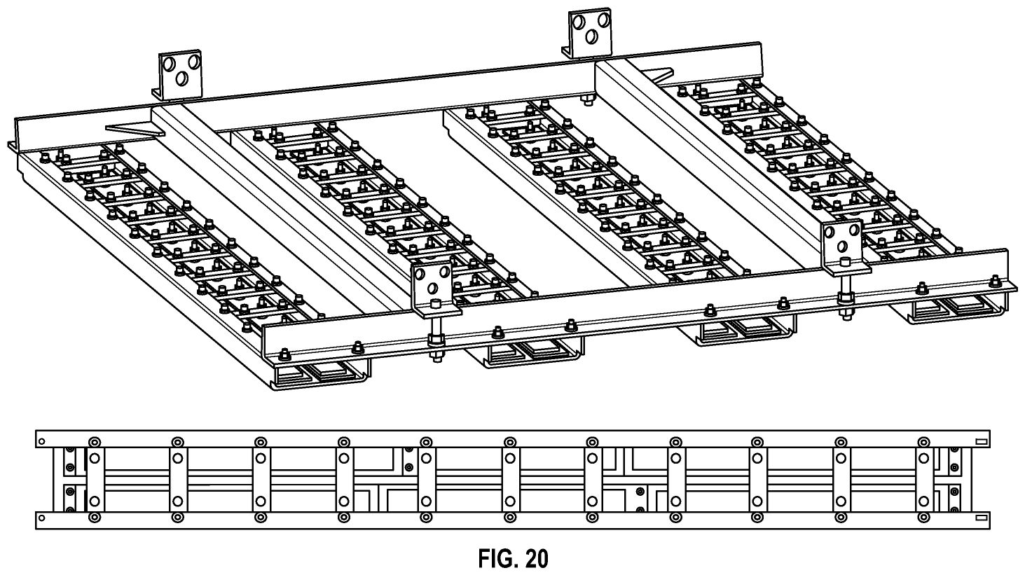

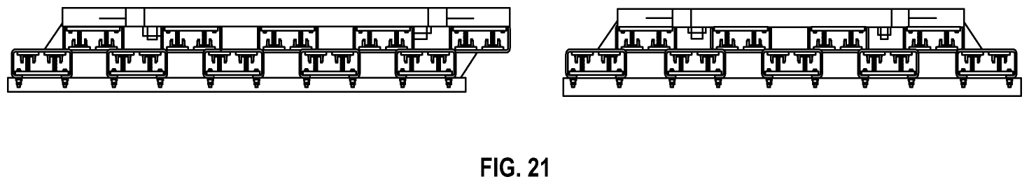

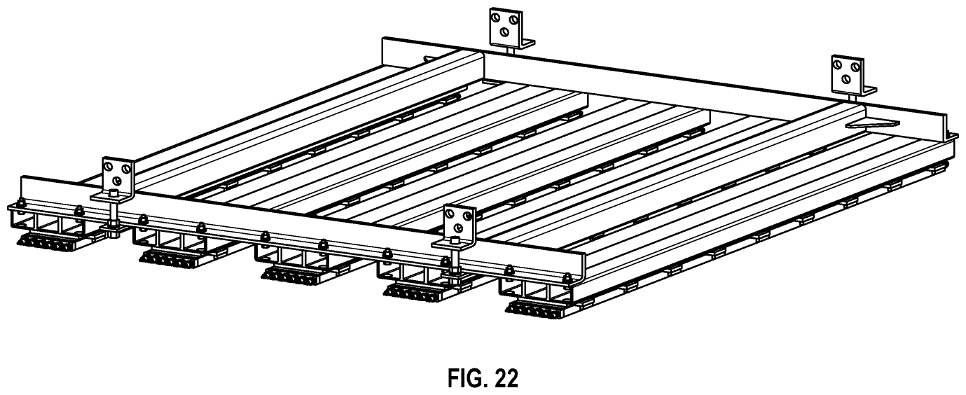

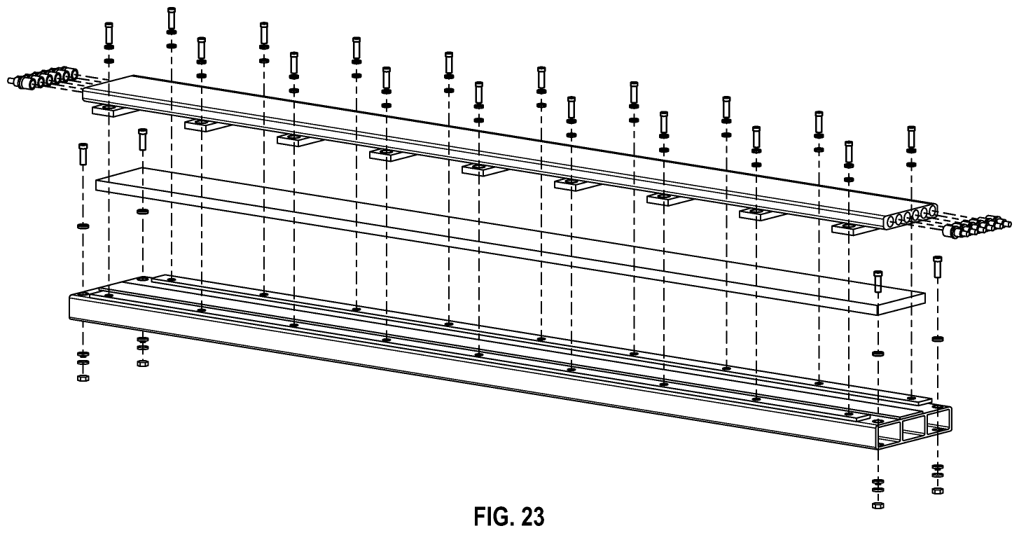

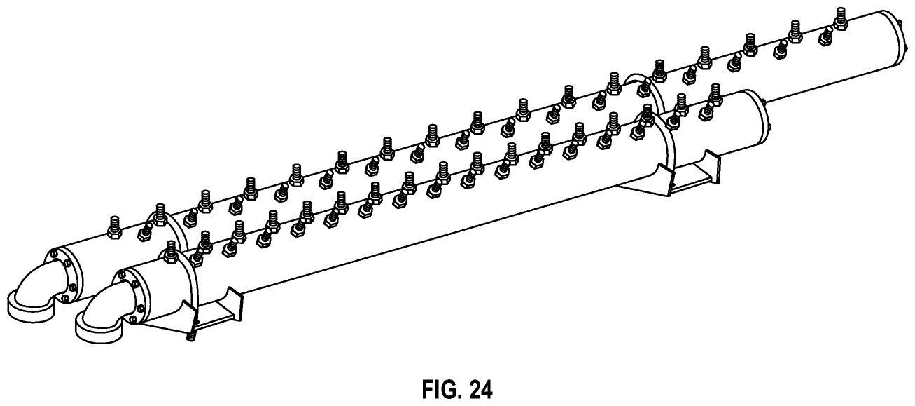

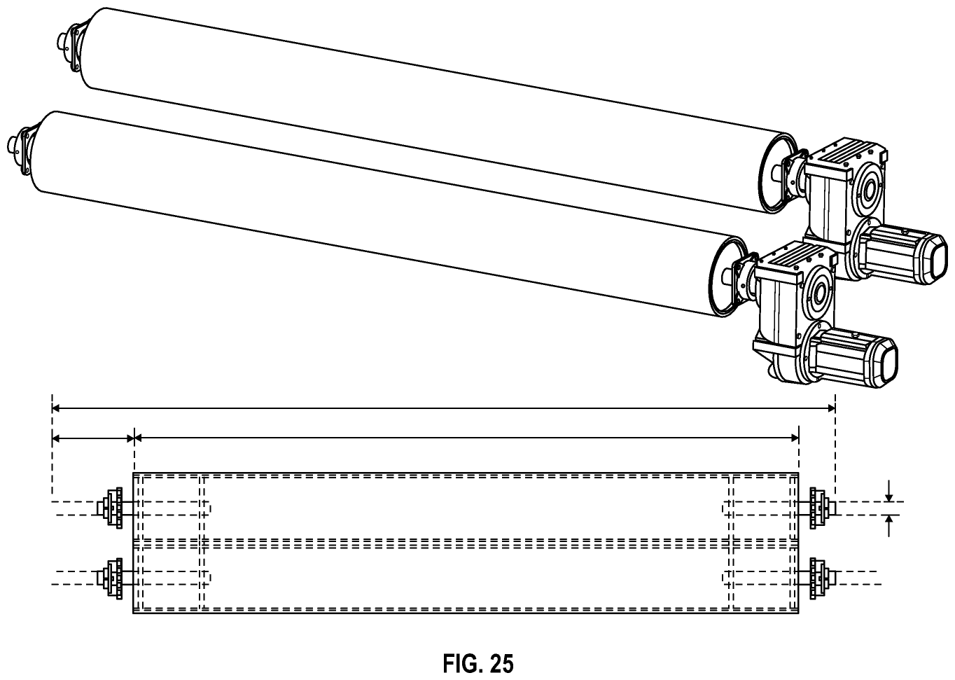

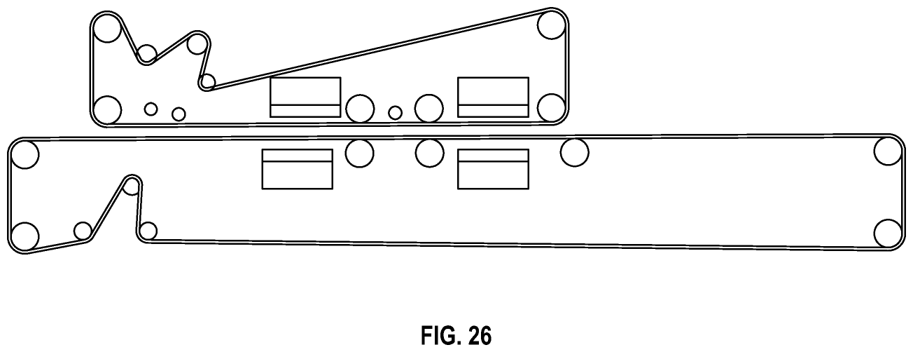

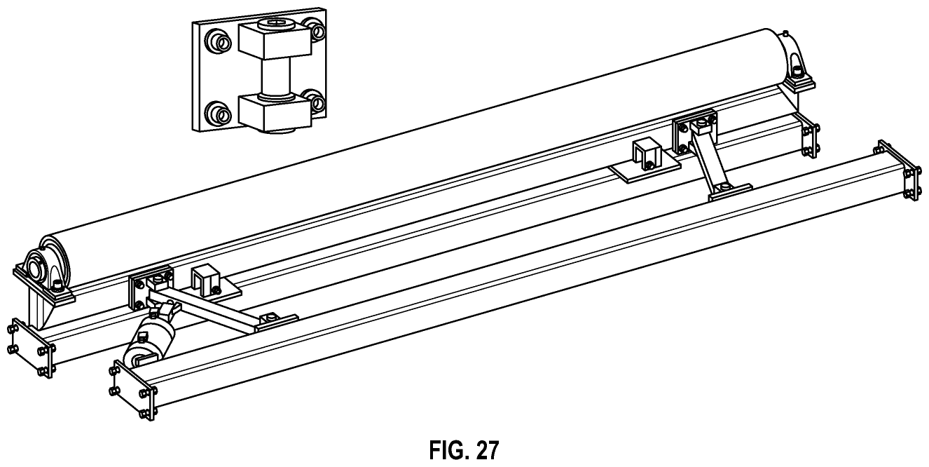

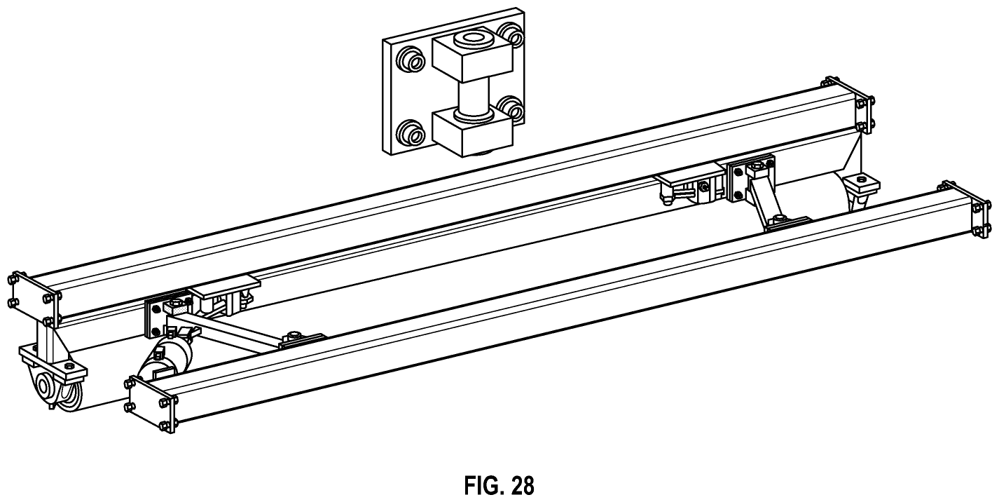

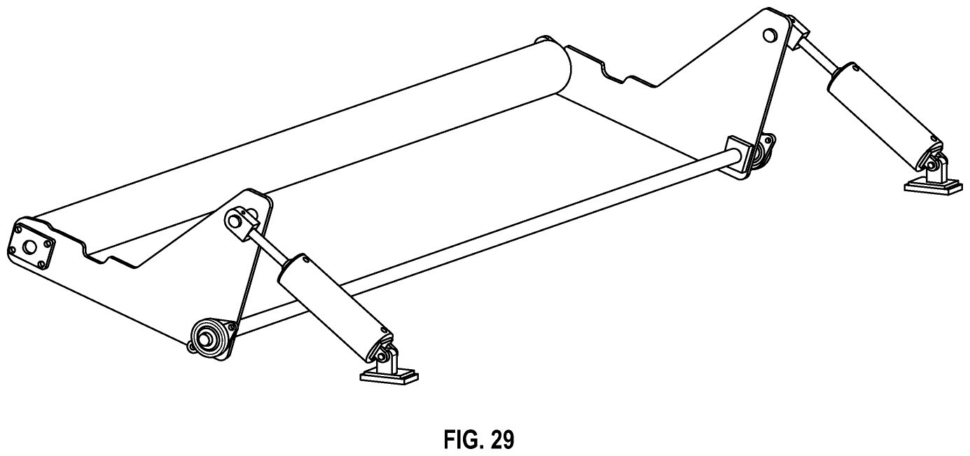

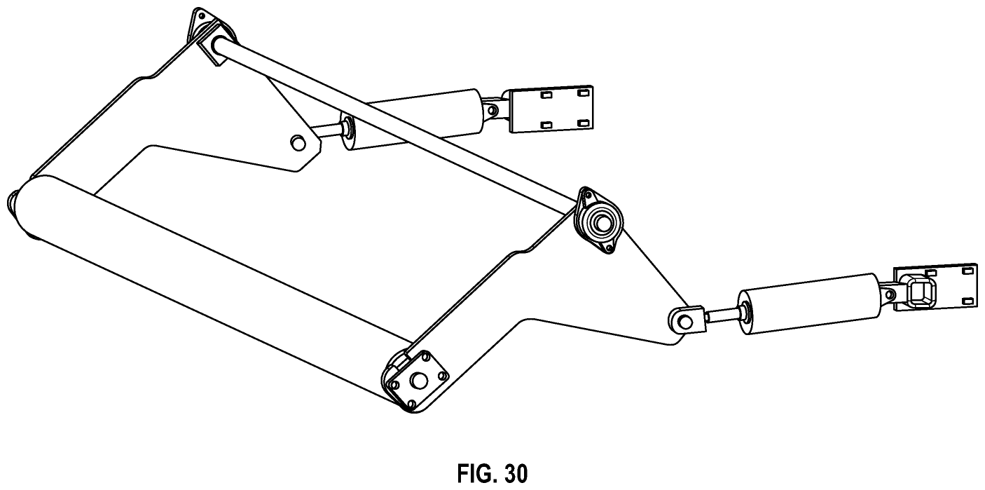

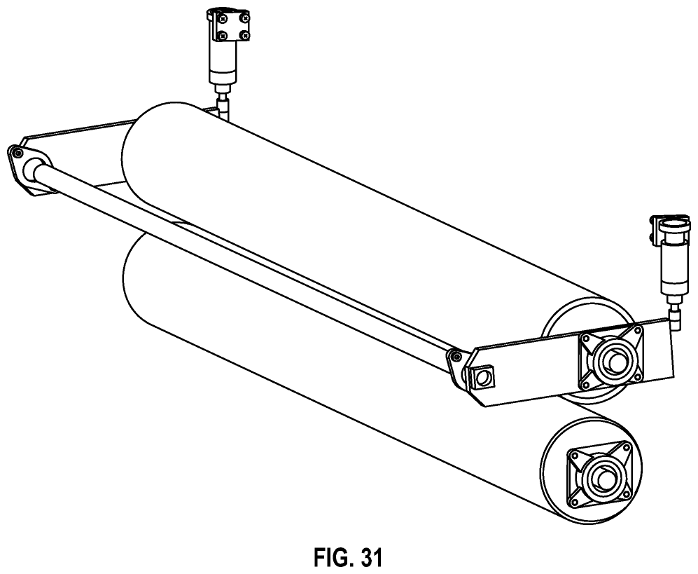

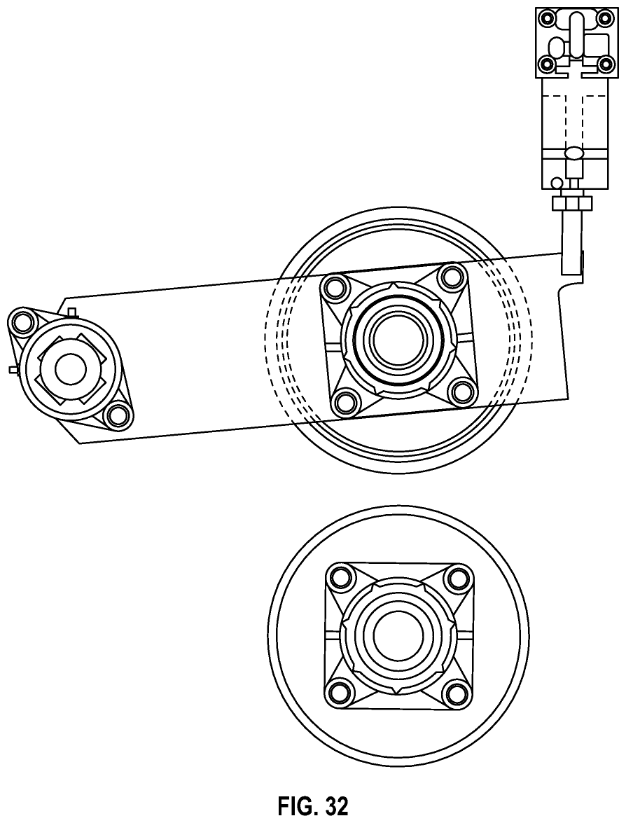

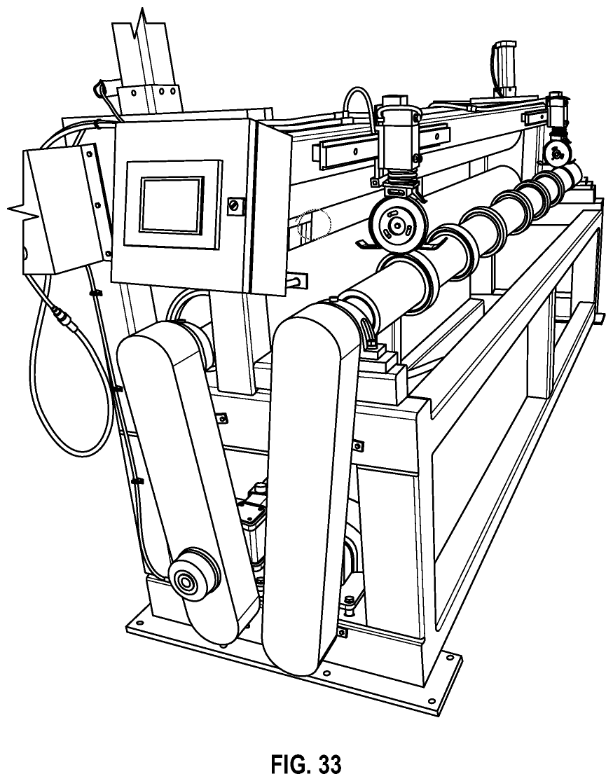

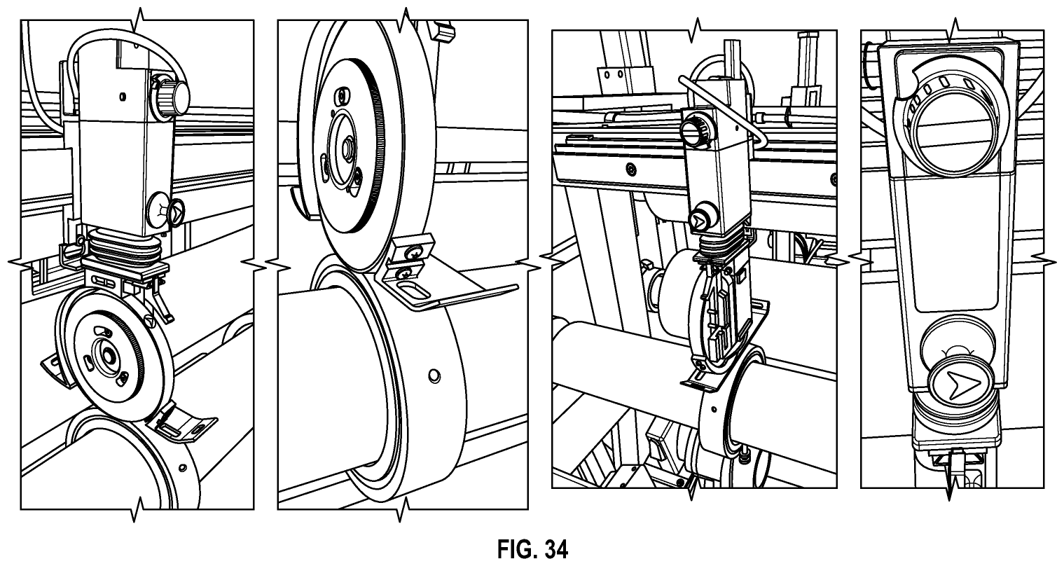

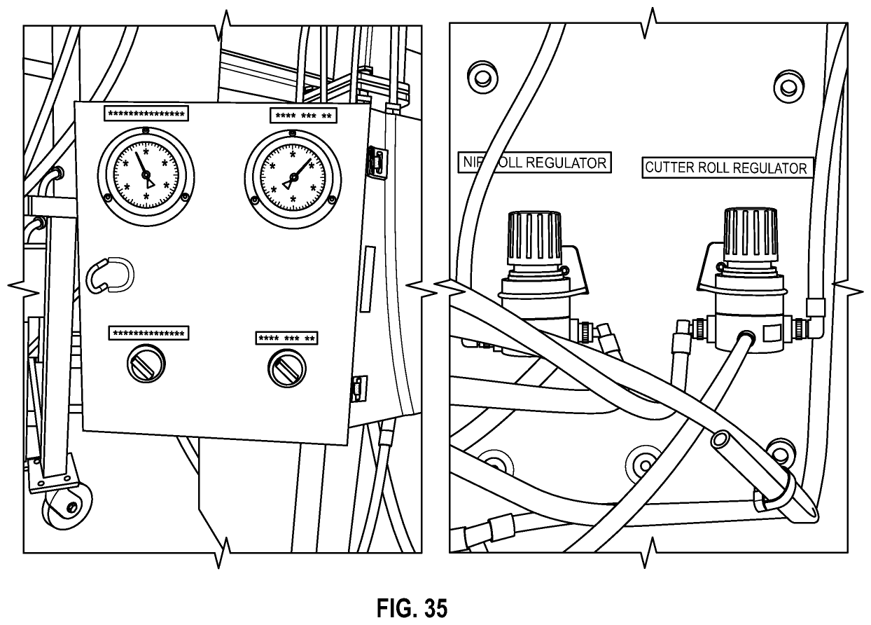

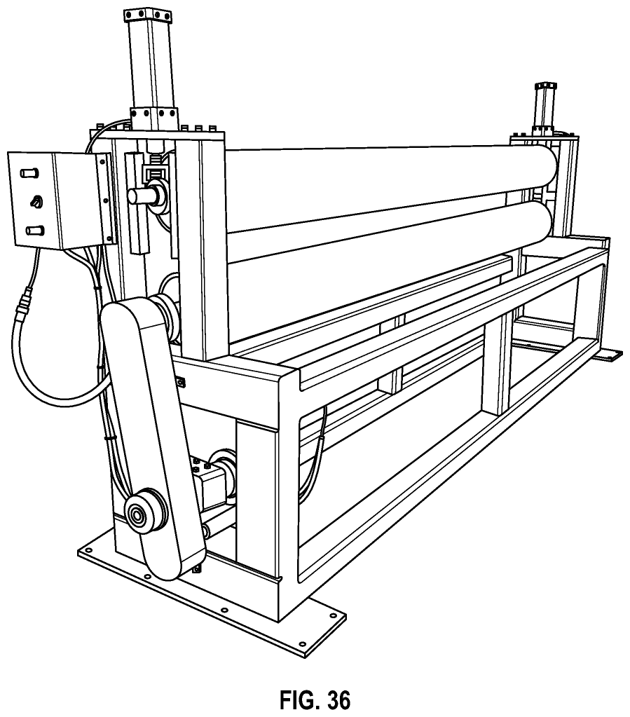

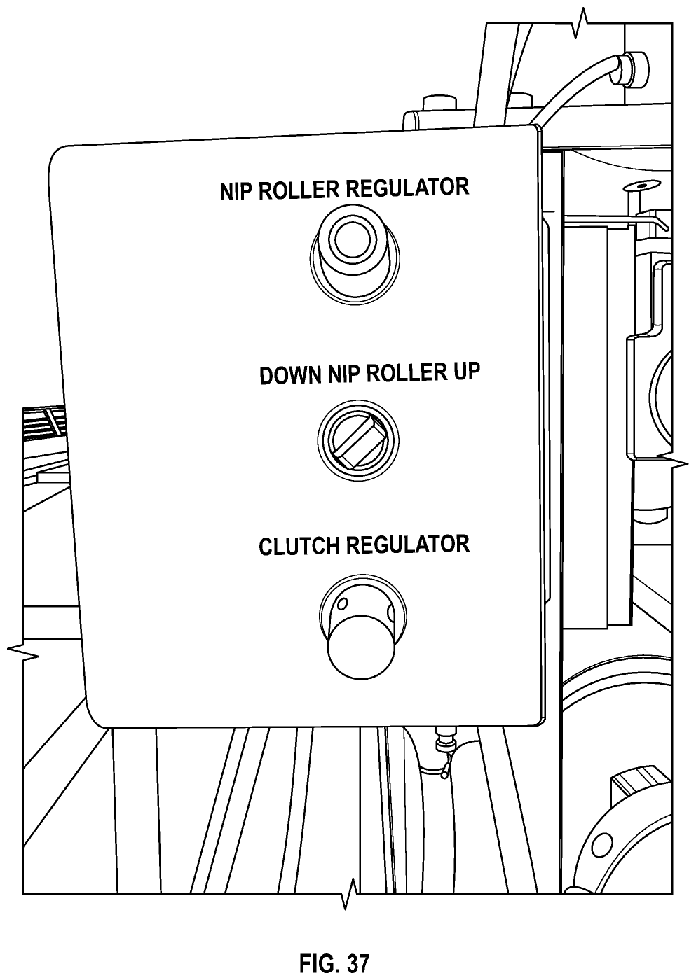

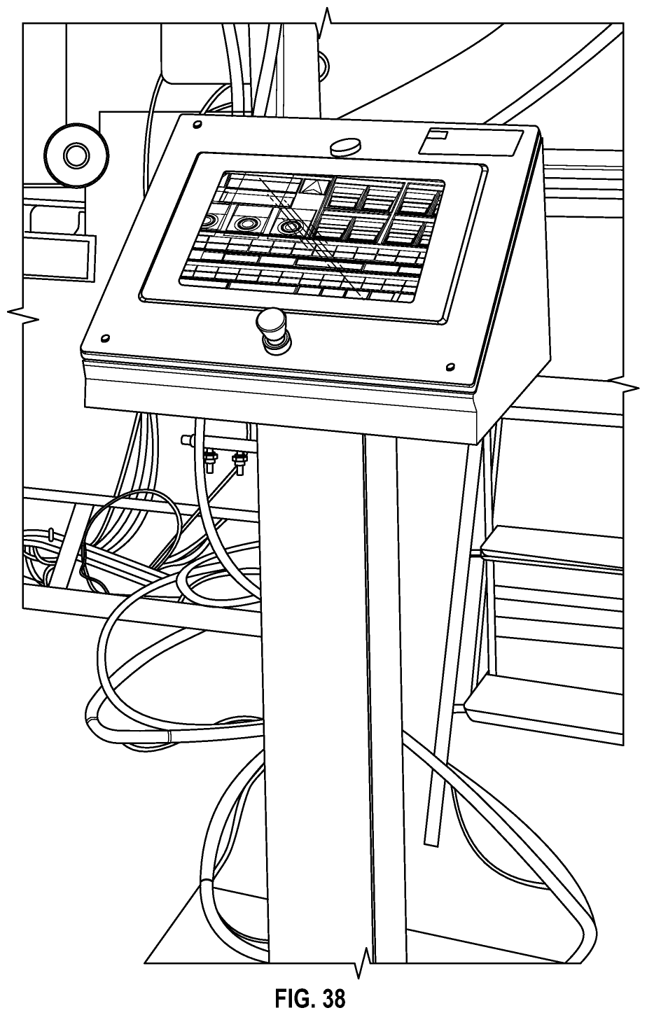

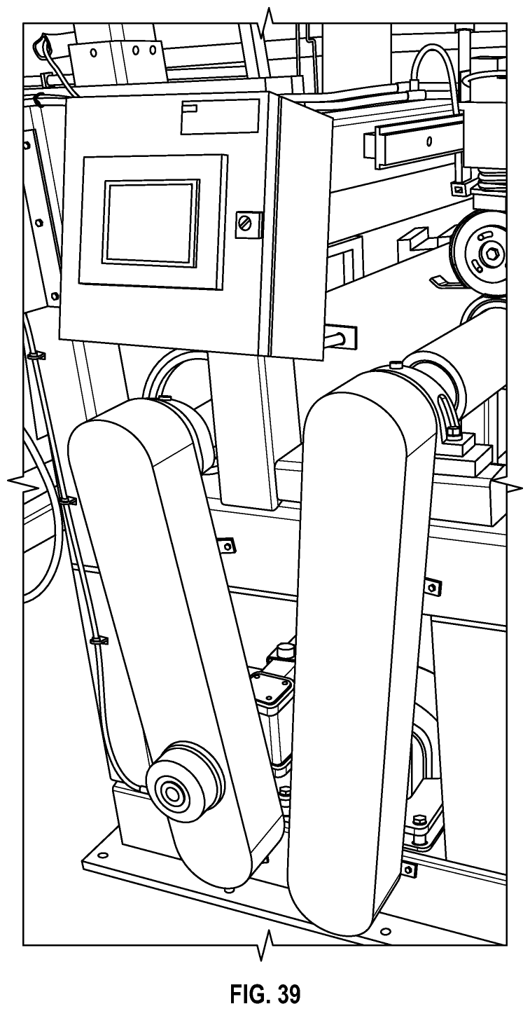

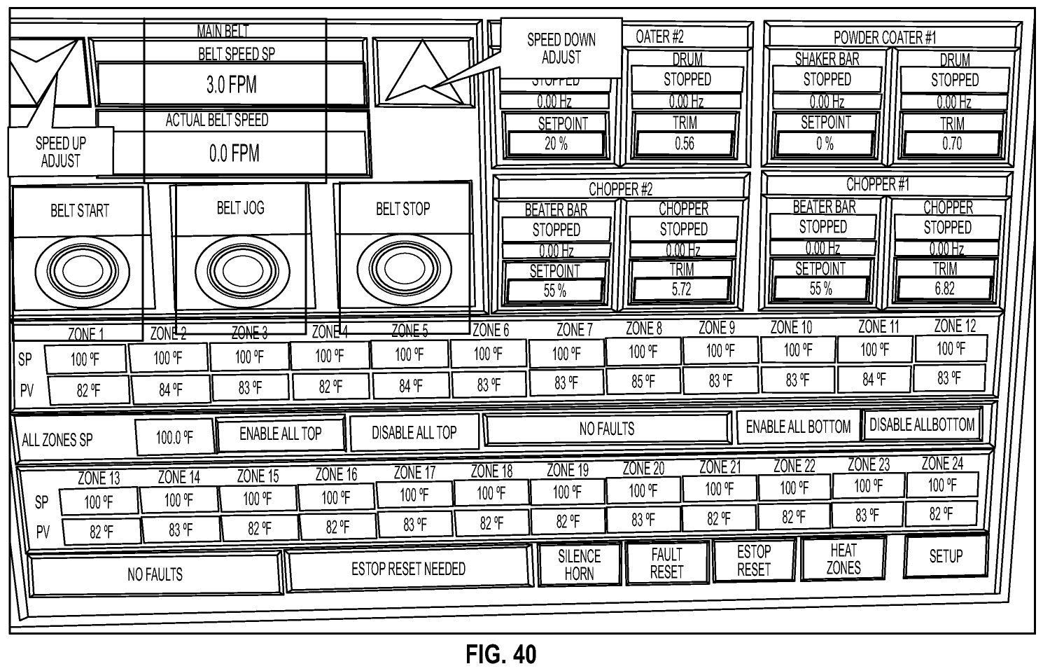

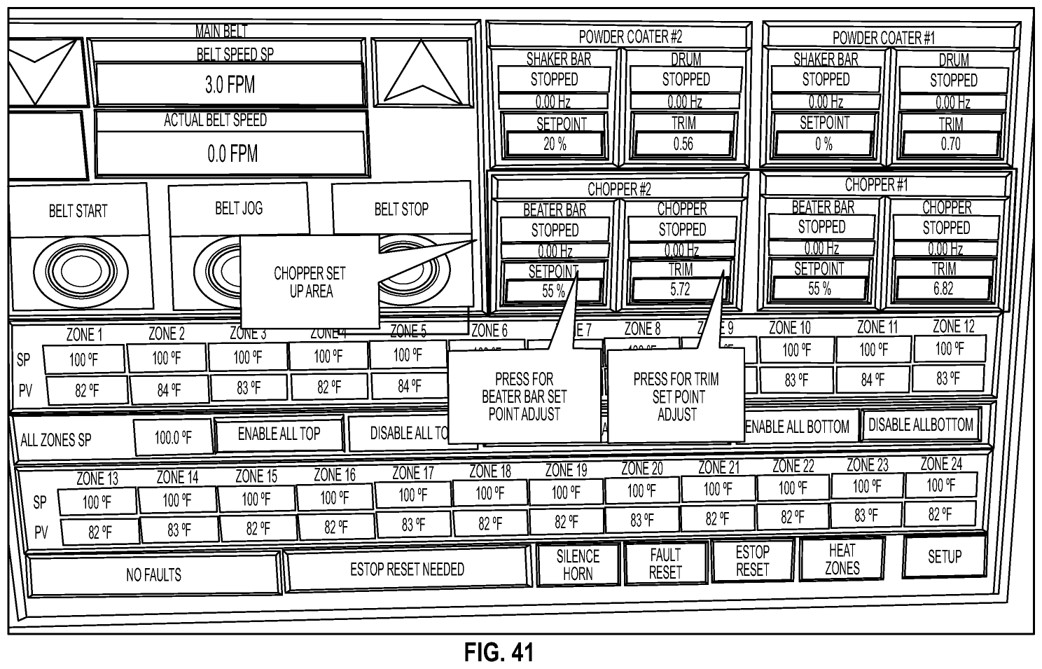

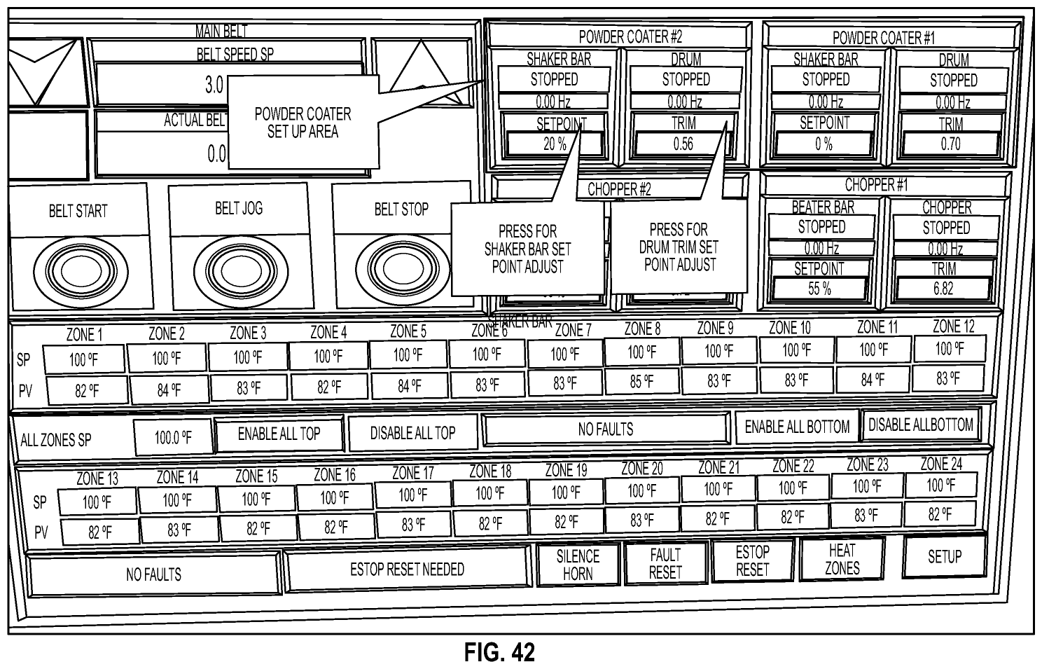

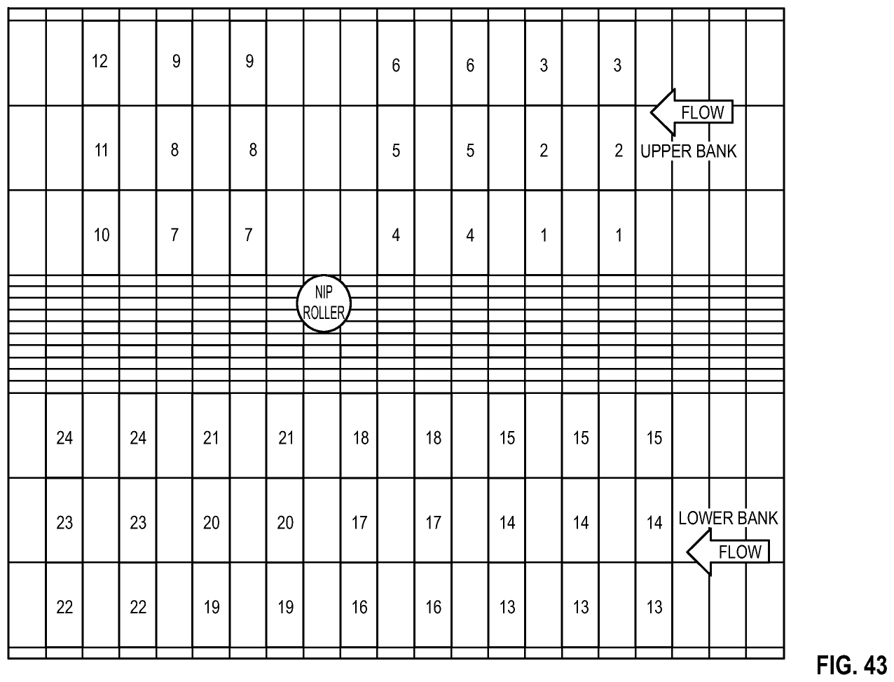

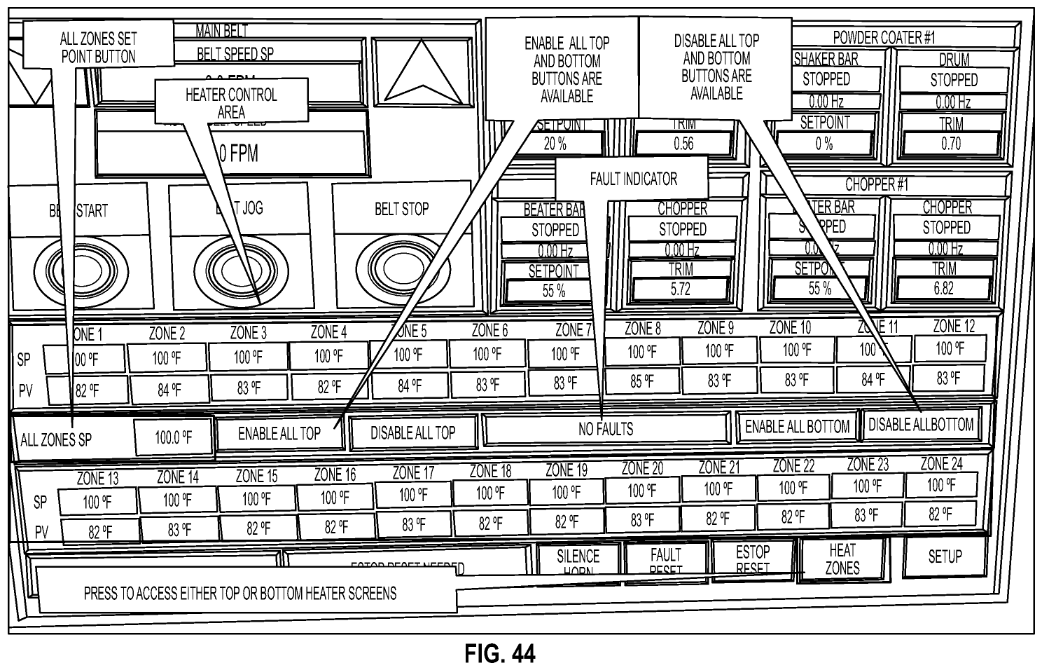

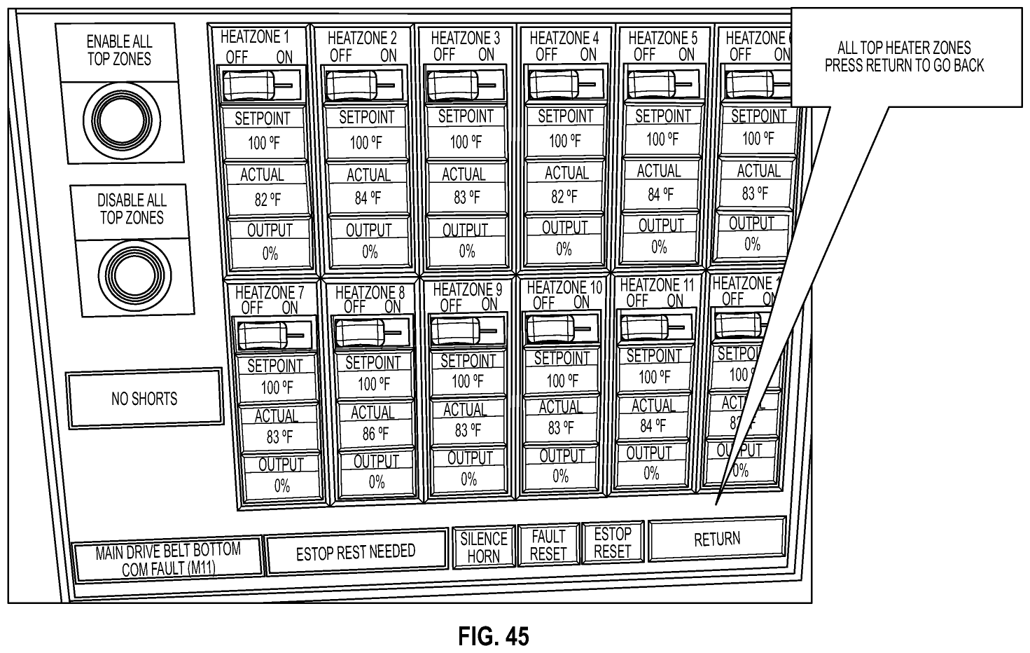

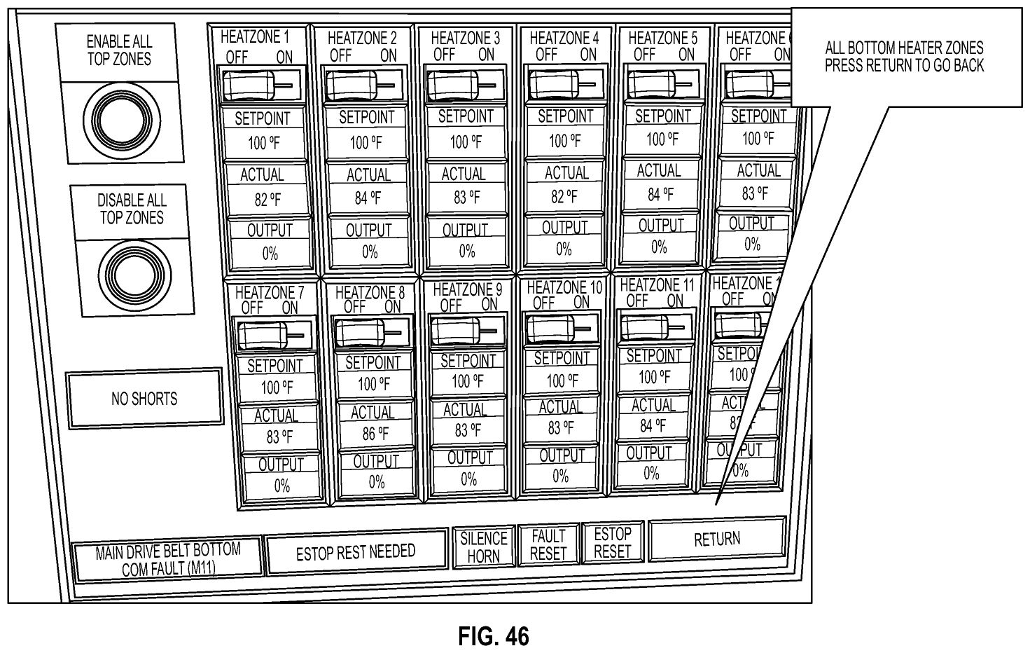

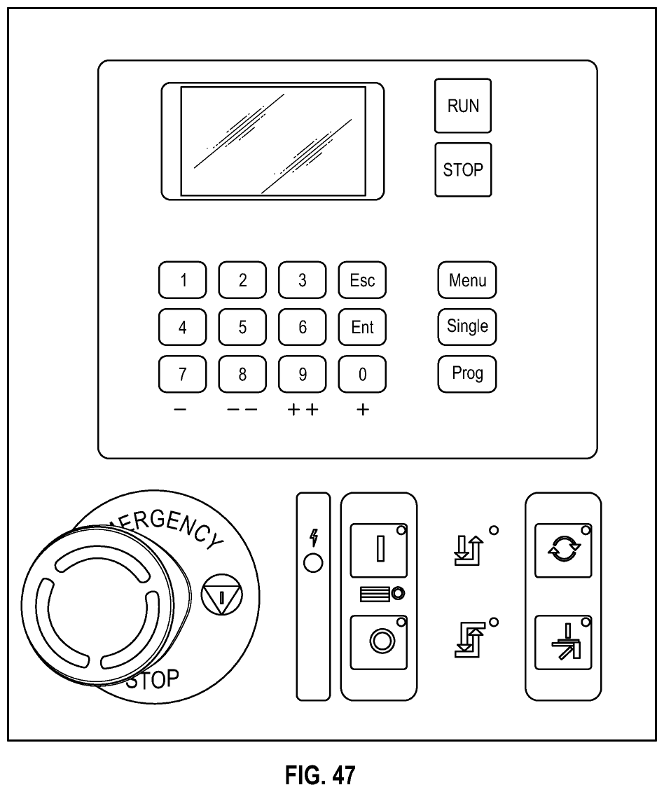

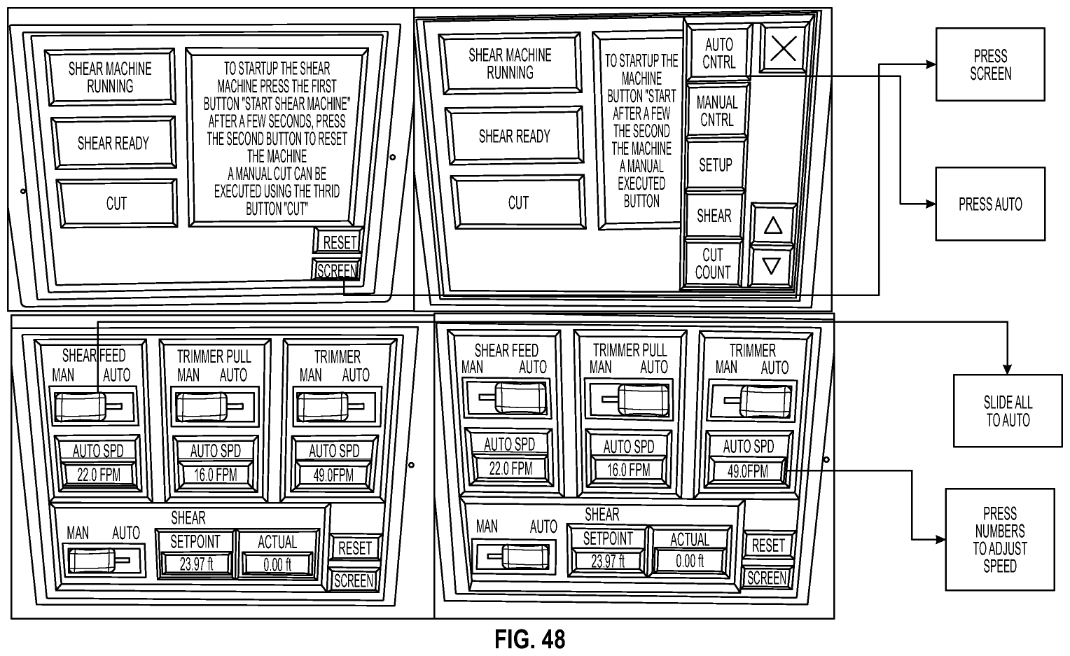

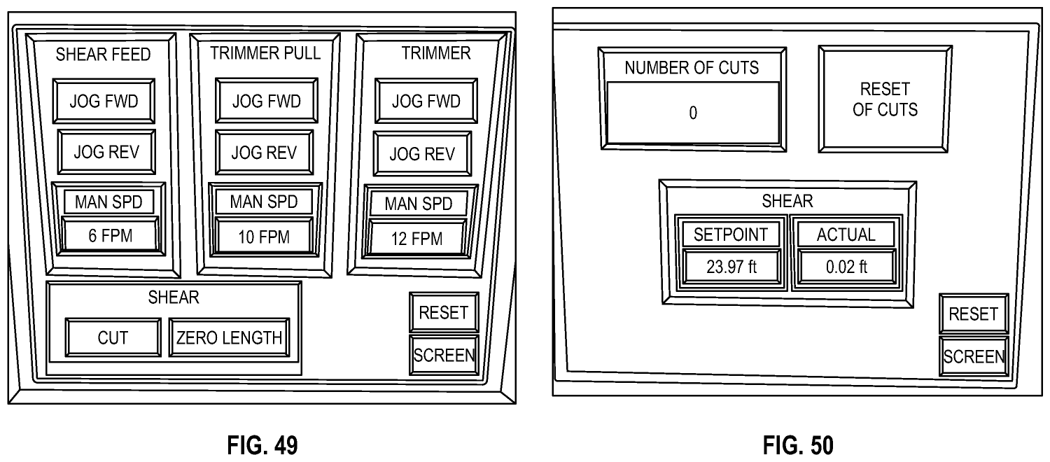

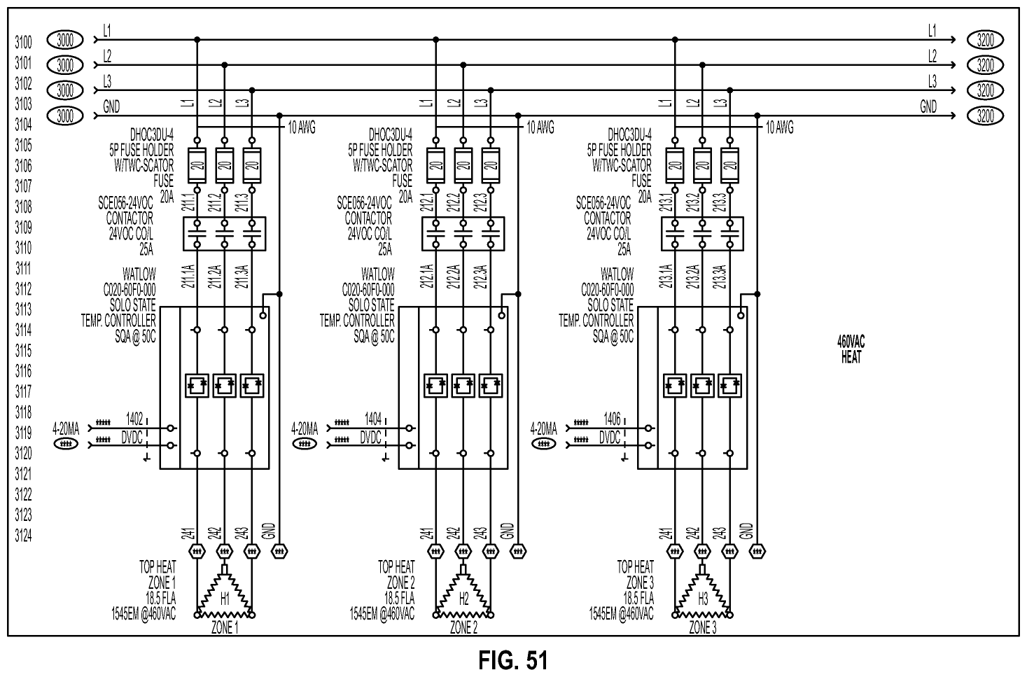

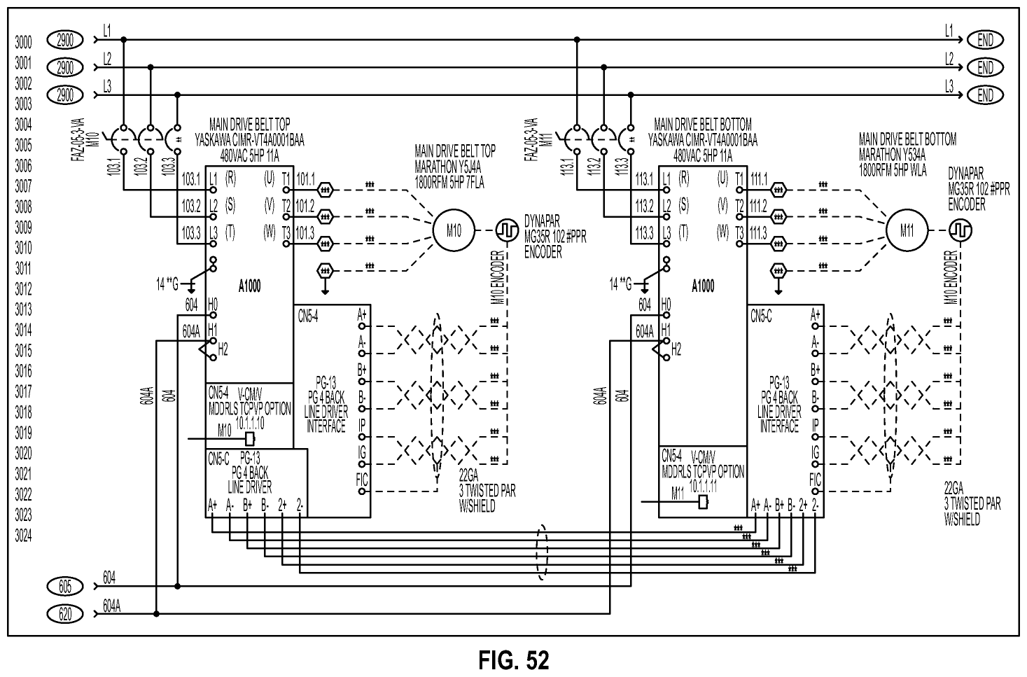

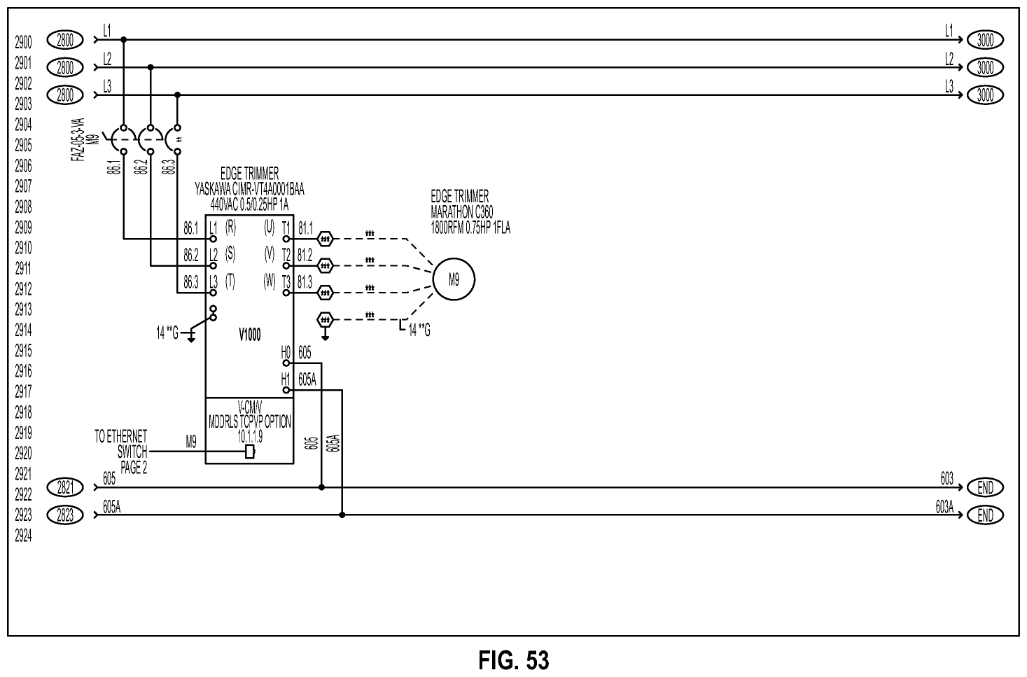

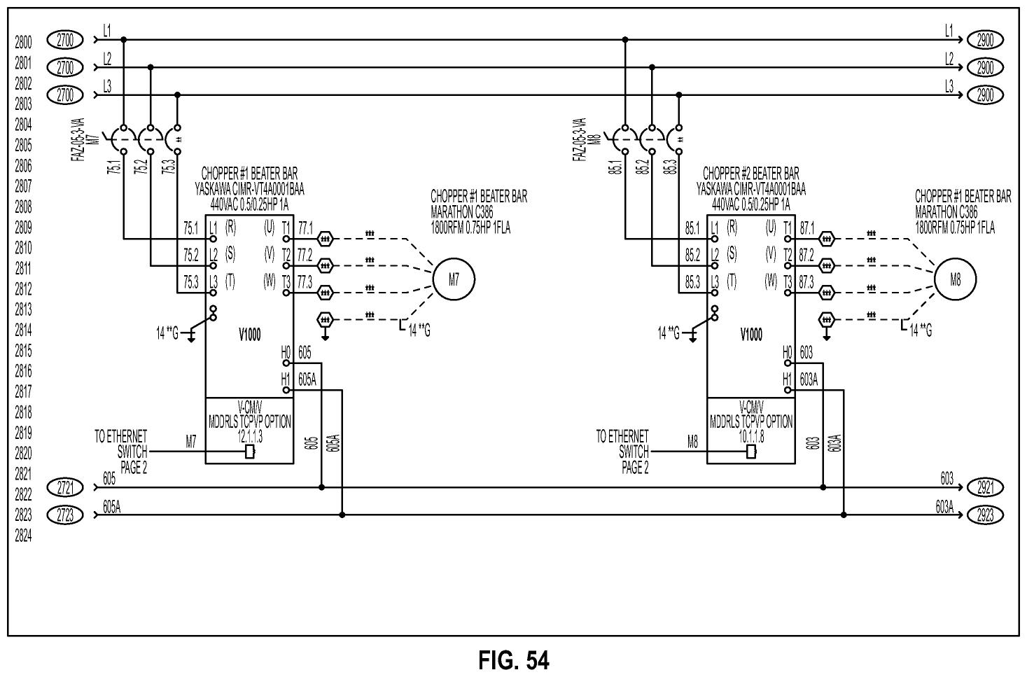

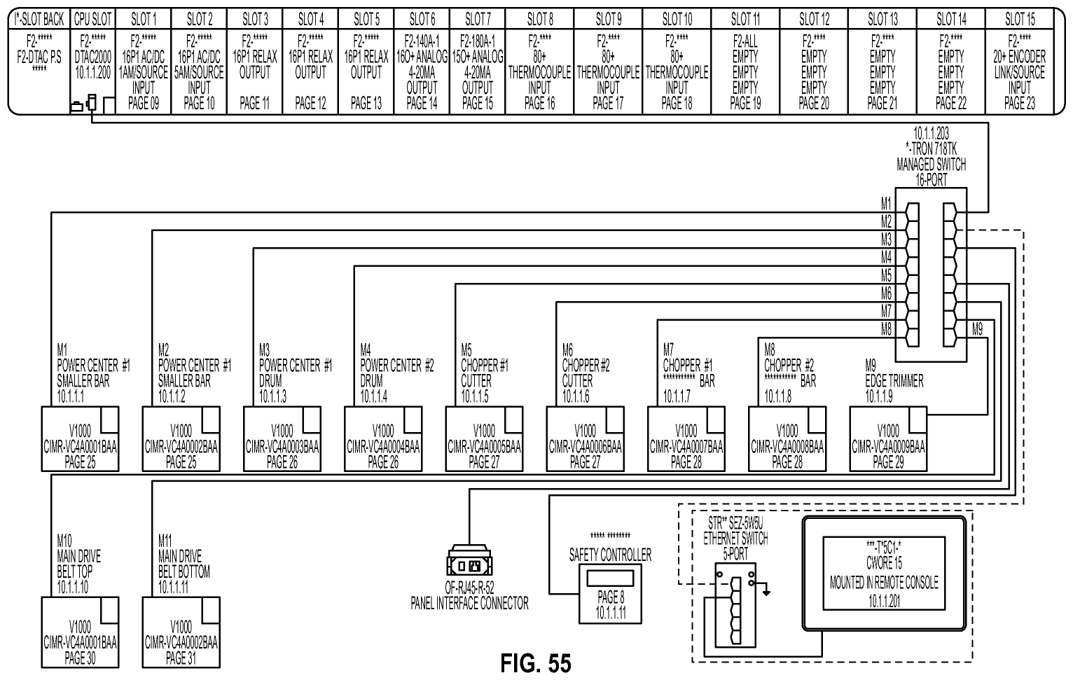

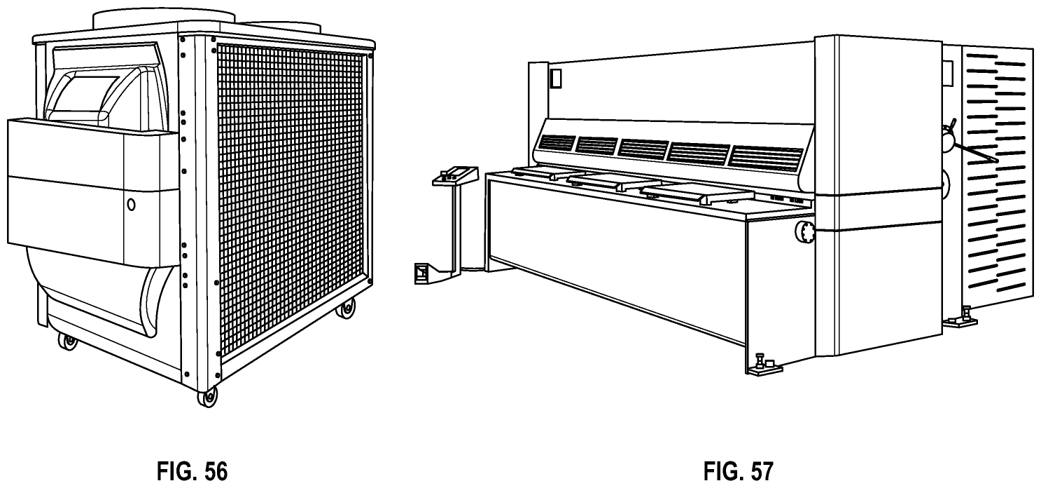

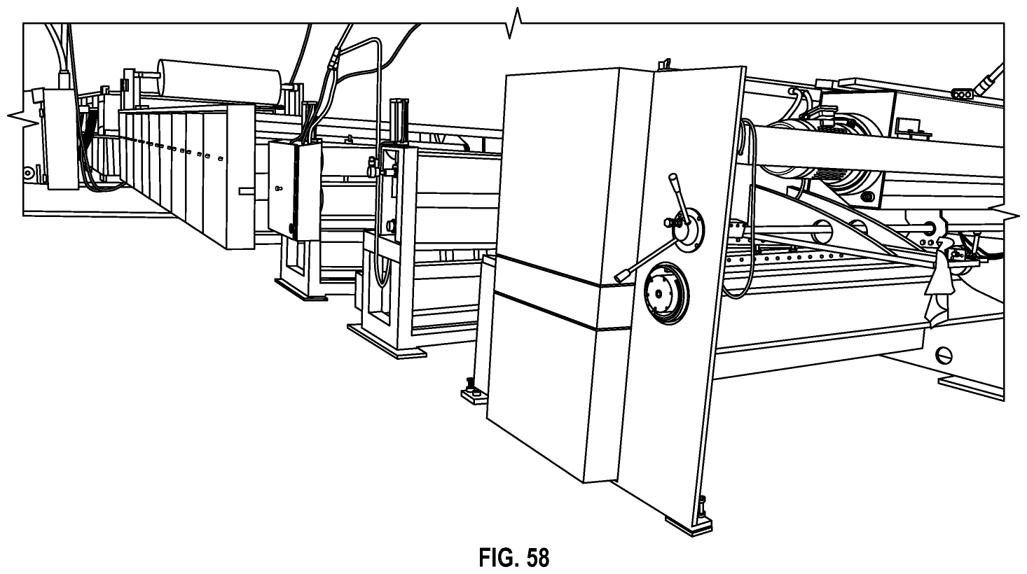

As seen in FIGS. 1-3, the system may comprise of a conveyor element, heating element(s), cooling element(s), and/or constituent component distribution element(s). Each of the components above that may comprise these various elements may be configured in accordance with several embodiments of this disclosure as described below.

Lower Unwind

### Major Components:

The lower unwind unit is comprised of:
Arbor that supports the scrim roll
Two unwind rollers
Scrim Tension Roller

Loading Sequence/Operation:

a. Open the Safety Chuck Locks on the scrim Arbor.
b. Load Scrim Arbor into Scrim Roll
c. Load Arbor into the Safety Chucks.
d. Thread scrim from the bottom of the roll, over the first roller, then down and under the lower roller, then back over the second top roller.
e. Set Scrim controller to auto
f Adjust the pressure on the lower roller to optimize the scrim feed.
g. Scrim will index as the lower roller is raised due to unwinding and keep pace with the machine.
Note: You may occasionally have to adjust the scrim unwind pressure to optimize the feeding of the scrim roll.

Chopper 1 & 2

### Both Chopper 1 and Chopper 2 are Identical.

### Major Components:

Glass Feed System (Creel)
S Wrap Assembly
Chopper Anvil
Chopper Cutter
Chopper Nip (air actuated)
Break Up Device System

Operation:

a. Feed Glass through Creel System
b. Wrap the glass through the S Wrap system
c. Open Chopper Nip Roll
d. Place Glass in Nip Roll/Copper Anvil area
e. Close Chopper Nip Roll
f. Program Feed and Speed
Note: It is important to watch during operation for glass wrap-up on the nip roller. This will indicate if an adjustment is needed in the glass feeding or creel system.

Powder Coater 1 & 2

### Both Powder Coater 1 and Powder Coater 2 are Identical.

Major Components:
Powder Hopper
Powder Baffle Assembly
Power Shaker Bar Assembly
Powder Doctor Blade

Operation:

a. Adjust the Powder Baffles to adjust the width of the powder delivery depending on product dimensions.
b. Load hopper with Powder to Fill Line (Manually if no powder Delivery System is needed.
c. Adjust powder delivery doctor blade to ensure proper distribution of the powder
d. Adjust the speed of the shaker bar assembly
e. Set machine in auto when ready to begin delivery of powder.
Note: The shaker bars are suggested but not necessary for all types of powder. Their operation can be disabled, if installed but not required, in a control panel.

CATWALKS 1 & 2 Catwalks are identical. They are positioned to allow access to the powder system and the choppers.

Upper Unwind

The upper rewind is identical to the lower unwind discussed above.

### Safety

Loading this unit is very treacherous and care must be taken not lo fall or gel caught in a pinch point. This should be attempted only by trained personnel.

### Operation/Loading

a. Unplug the unwind unit
b. Retrieve scrim from inventory
c. Load Scrim on Arbor
d. Load Arbor and Scrim on upper unwind unit with fork truck. (Note: This step requires 3 people and a skilled fork truck driver.)

Heater Section 1 & 2

### Major Components

Section 1 Upper 4 Heaters
Section 1 Lower 5 Heaters
Section 2 Upper 3 Heaters
Section 2 Lower 4 Heaters
Section 1 Heater Frame Adjustment
Section 2 Heater Frame Adjustment
   An exemplary Heater Zone set up can be seen in the figures.

Operation

a. The height of these are manually controlled in banks
b. Temperatures are controlled via control panel programming and can be adjusted as needed for different products.
Note: The adjustment of these heater elements must be done with care. Too much pressure on the belt can cause slippage and damage to the belt. Too much heat can also cause damage to the belt.

Heater Frames & Adjustment

The heater banks are manually raised and lowered by adjusting the leveling at one of 4 (four) points on each upper assembly.

Operation

a. Loosen lock nut.
b. Adjust heater frame up and down while belt is moving
c. Ensure heater frame is level
d. Tighten Lock not as appropriate.
Note: In some situations, leaving the heater frames free and able to float is advisable.

Heater Channels-Assembly & Mounting

### Major Components

Heater Channel Weldments
Heating Elements
Upper and Lower Channels
High Temp Adhesive
High Temp Wiring and components

Installation and Removal

a. Cool down machine.
b. Safely cut power to the entire machine.
c. Disconnect the wiring from the terminals.
d. Each heater buck assembly has 4 bolts holding the heater in place.
e. Support the heater so that it does not contact belt.
f. Remove the 4 bolts holding the heater buck.
g. With proper assistance and heater install frame, remove the heater by sliding out.
Note: Care must be taken not to tear the belt.

Cooling Section 1 & 2

### Major Components

### Section 1 Upper 4 Cooling Elements

### Section 1 Lower 5 Cooling Elements

### Section 2 Upper 5 Cooling Elements

### Section 2 Lower 5 Cooling Elements

### Section 1 Upper Frame Adjustment

### Section 2 Upper Frame Adjustment

Operation:

a. The height of these are manually controlled in banks
b. Temperatures are controlled by the Chiller and the bypass valve
Note: The adjustment of these cooling elements must be done with care. Too much pressure on the belt can cause slippage and damage to the belt. Too much heat can also cause damage to the belt.

Cooling Frames & Adjustment

The cooling element banks are manually raised and lowered by adjusting the leveling at one of 4 (four) points on each upper assembly similar to the heating elements.

Cooling Channels Assembly & Mounting

### Installation and Removal

a. Cool down machine.
b. Safely cut power to the entire machine.
c. Safely drain water from the manifolds and elements.
d. Each Cooling Manifold has tight fitting hoses which have to be removed to remove the unit.
e. Each cooling element assembly has 4 bolts holding the heater in place.
f. Support the Element so that it does not contact belt.
g. Remove the 4 bolts holding the Element.
h. With proper assistance and heater install frame, remove the Element by sliding out.
Note: Care must be taken not to tear the belt. Also, ensure the unit is flat before reassembly into the cooling frames.

Cooling Manifolds & Connections

### Major Components

Section 1 Chilled Supply Manifold LH & RH
Section 1 Hot Return Manifold LH & RH
Section 2 Chilled Supply Manifold LH & RH
Section 2 Hot Return Manifold LH & RH
Section 1 Return Manifold Restricting Valve LH & RH

Operation:

a. Turn Chiller On.
b. Set Chiller Temp to process parameters.
c. Adjust the flow on the Section 1 Manifold Restricting valves according to process.
d. Allow system to run for 30 minutes prior to starting production.
Note: The adjustment of these manifolds must be done with care. Too much flow restriction can cause damage to the cooling channels or belt, or both.

Chiller—Supplied by Owner

### Major Components

20 Ton Chiller
Optional 2nd 20 Ton Chiller
Optional Heating unit for temp control.
Blue (Supply) and Red (Return) hosing.
Fittings

Operation:

a. Turn Chiller On.
b. Set Chiller Temp to process parameters.
c. Adjust the flow on the Section 1 Manifold Restricting valves according to process.
d. Allow system to run for 30 minutes prior to starting production.

Main Drive & Tracking

### Major Components

Main Drive Motors
Main Drive Rolls
Top and Bottom Belts
Top and Bottom Tracking System
Top and Bottom Take Up System
Other Support Rollers

Operation:

a. The main drive units are controlled by a PLC.
b. The main drive rollers power the belts top and bottom to synchronize the belt speeds.
c. All belt alignment is automatic.
d. If the belt is not tracking, check the alignment and wear of the belt as well as ensure that the alignment sensors are free and clear of debris.
e. Manual movement of the tracking rollers may be needed occasionally to free up the belt.
Note: The adjustment of the belt tracking if not done properly can result in a damaged belt.

Main Drive Motors and Rollers

### Major Components

Main Drive Motors
Main Drive Rolls

Operation

a. Upper and Lower drive units are controlled by a PLC and the setting in the operator panel for speed.
b. Rollers turn in opposite directions clockwise and counter clockwise to allow synchronization of the belt top and bottom.
Note: Adjusting any parameters relating to the speed of these independent of one another may result in machine and or belt damage. This should not be done except by an experienced technician.

Top & Bottom Belts

### Major Components

Top Drive Belt
Bottom Drive Belt

Installation

a. This should only be attempted by a factory trained technician. Many times, the belt supplier will for a charge provide belt seaming.
b. Belts need to be purchased to proper length to avoid field cutting the ends.
c. Multiple belt connection type are available but certain embodiments utilize a 2″ overlap seam.
d. Belt should be prepped and square.
e. Remove all power from the machine.
f. Remove all air from the machine.
g. Feed belt.
h. On a flat heat resistance surface, align and clamp the belt.
i. Utilizing a heating iron, seaming tape, and experience start from the center and work outward equally in both directions and ensure the seam is smooth and cooled before trying to run the machine.

Operation

a. Belts run together. NEVER run one belt without running the other.
Note: Adjusting any parameters relating to the speed of these independent of one another may result in machine and or belt damage.

Top & Bottom Belt Tracking System

### Major Components

Top and Bottom Tracking System (drawing on following pages)
Top and Bottom Take Up System (drawing on following pages) Other Support Rollers

Operation:

a. The tracking system is powered by air and is controlled by the tracking sensor on each unit.
b. All belt tracking alignment is automatic
c. If the belt is not tracking, check the alignment and wear of the belt as well as ensure that the alignment sensors are free and clear of debris.
d. Manual movement of the tracking rollers may be needed occasionally to free up the belt.
Note: The adjustment of the belt tracking if not done properly can result in a damaged belt.

Top & Bottom Belt Take-Up System Internal

### Major Components

Top Take Up System
Bottom Take Up System
Other Support Rollers

Operation:

a. The belt tension system is powered by air and is controlled a pressure regulator.
b. Once set is should not be altered except by a factory trained professional.
c. If belt is slipping adjustments may be made to this system.
d. Manual movement of the belt tension rollers will happen if the air is not engaged.
e. The take up rollers are on independent articulating bearings and will adjust if minor stretch or alignment issues are in the belt.
f. Belt must be shortened or repaired once the unit is fully extended

Nip Rolls 1 & 2

### Major Components

Nip Roller 1 located after Heating Section 1
Nip Roller 2 Located after Heating Section 2 prior to Cooling Section 1

Operation:

a. The nip roller pressure is set manually via a pressure regulator located near the Operator Control panel.
b. Pressure is increased by increasing air pressure to the two cylinders.
c. Stops are located on the LH and RH side of the machine at each nip roller to allow for manual setting of the nip gap.
Note: The adjustment of the nip roller plays a key component to material consolidation and care must be give not to over or under compress.

Nip Roll & Edge Trim for Width Control

### Major Components

Cutter LH and RH
Cutter Knife Ring LH and RH
Nip Roller

Operation:

a. The cutter and cutter ring need to be sharp and aligned.
b. Begin by setting the cutter rings at the correct dimension for slitting the product.
c. Align the cutter on top of the ring.
d. Disengage the cutter until you are ready to cut.
e. Set the nip roller pressure.
f Set the Cutter roller speed to process setting.
g. Set the nip roller speed to process setting.
h. Open the Nip Roller until material is engaged.
i. Close nip roller.
j. Tension should be on the material exiting the main Laminator.
k. Tension can be adjusted by adjusting the nip roller speed and tension on the nip roller friction drive.
l. These are regulated by the controller and the pressure gauge on the unit.

Nip Roll for Shear Feed & Length Control

### Major Components

Nip Roller

Operation:

a. The Nip roller for the shear feed controls and measures the length set in the rear operator panel.
b. Begin by setting the desired length in the operator panel per the material specification. Lengths may vary slightly due to the accuracy of the unit, but are within +/−½″.
c. Set desired speed in control panel per the material specs.
d. Open the nip roller via a selector switch on the unit.
e. Once the material is through the edge trim nip rollers, pass it through this unit.
f. Close the nip roller with the selector switch.
g. Feed material into the shear.
h. Do a short cut to trim off leading edge.
i. Set desired length.
j. Shear needs to be powered on.
k. Tension should be on the material exiting the slitter nip roller.
l. Tension can be adjusted by adjusting the nip roller speed.
m. Set nip roller tension on the nip roller pressure regulator.
n. Set the nip roller clutch pressure to optimum spec for the product being run.
o. Both the nip roller pressure and clutch pressure are regulated by the pressure gauge on the unit above and below the pressure switch.
p. Check the length of the first piece and periodically through the run.

Electrical Control Cabinet

An exemplary control cabinet can be seen in the figures.

Operator Control Stations

The main operator control station is located across from the main panel at the entrance of the material to the heating chambers.

Major Components
Main Operator Control Panel
Nip-Slitting-Shear Control Panel

Configuration:

Main Control Panel controls
All Main Machine Functions
All Belt Functions
All Heater Functions
All Choppers/Powder Functions
   Nip-Slitting-Shear Control Panel controls:
All Shear/Nip speeds
All Shear length
All nip pressures and clutch pressures are set via the pressure regulators at each station.

Machine Settings and Adjustments

### Major Components

Main Operator Control Panel
Nip-Slitting-Shear Control Panel

Operation:

a. Parameters for the various components described herein for each specific product (or constituent laminate component) will generally be contained in a product set up sheet. The adjustment any parameter should only be done by a skilled factory trained individual. Damage to the system may result from improper settings and or combinations. All Air Controlled devices are not controlled or monitored by the PLC or main panel. Pressure settings are all manual and not controlled by the PLC or operator control panel.

Conveyor Speed Settings

### Operation:

Speed is controlled by the PLC through the Main Operator Control Panel
Speed is adjustable from 0-18 feet per minute.

Chopper Settings

### Operation:

a. Chopper 1 and Chopper 2 have two programmable settings that can be adjusted from this point.
b. The Beater Bar Speed and the Chopper Speed
c. Beater Bar Speed—this affects distribution of the chopped glass
d. Beater Bar Adjustment
Adjust by touching Setpoint
Set from 0-100% based on Product Set Up Sheet
Adjust as needed to get proper distribution
   e. Chopper Speed—this affects the weight or amount of glass dropped on the belt. Set per Product Set Up Sheet.
   f. Chopper Speed Adjustment
Adjust by touching Trim
Set from 0-10 based on Product Set Up Sheet
Adjust as needed to get proper distribution
   g. Visual indications of the unit running are available to view in this area. Speed of each is indicated in Hz on the display.

Powder Coater Settings

### Operation:

a. Powder Coater 1 and Powder Coater 2 have two programmable settings that can be adjusted from this point: the Shaker Bar Speed and the Chopper (or Drum) Speed
b. Shaker Bar Speed—this helps to keep the powder evenly distributed along the drum.
c. Shaker Bar Adjustment
Adjust by touching Setpoint
Set from 0-100% based on Product Set Up Sheet
Adjust as needed to get proper distribution
   d. Drum Speed—this affects the weight or amount of glass dropped on the belt. Set per Product Set Up Sheet.
   e. Drum Speed Adjustment
Adjust by touching Trim
Set from 0-10 based on Product Set Up Sheet
Adjust as needed to get proper distribution
   f. Visual indications of the unit running are available to view in this area. Speed of each is indicated in Hz on the display.

Heater Settings

### Operation:

a. Heater specific temperatures are set per the relevant Material Specific Process Sheets.
b. Heaters are zoned.
c. Heater zones represent both top and bottom heaters.
d. A map of heater zones can be seen in the figures.
e. Heaters may be controlled in areas selected in the main control panel.
f. Buttons
Touching any Zone SP button will allow individual setting of any heater.
Two Enable All Buttons are available for both the top and bottom heaters
Two Disable All Buttons are available for both the top and bottom heaters
All Zones Set Point Button allows for easily changing the temperatures of all zones simultaneously.
   g. The Heat Zones Button allows access to screens that show only Top or Bottom Heaters all at once with additional information.

Nip Roll/Edge Trim Settings

### Operation:

This unit is independently controlled and not part of the main control cabinet or PLC System.
Shear must be Powered on and in AUTO for Nip/Slitter pane 1 to function.

Operation:

a. Nip-Slitting-Shear Control Panel
b. Power on the Nip/Slitter Control Panel
c. Once the shear is in auto and all lights are green then press SCREEN to access the menu
d. All parameter values are taken from the Product Recipe
e. Touch any parameter number to change its value.

Manual Control Screen (as seen in the figures)

a. You can adjust speed or Jog any motor.
b. You can also Adjust Cut and Zero Cut Length
c. Cut Count Screen
d. You can reset the sheet count from this screen
e. Also you can change the shear length.
f. Setup Screen
This screen allows you to setup any parameter.

Although the disclosure has been described and illustrated with respect to exemplary objects thereof, it will be understood by those skilled in the art that various other changes, omissions, and additions may be made therein and thereto without departing from the scope of the present disclosure.

1. A system for producing a composite structural laminate comprising:
a conveyor assembly configured to move a laminate base;
a first heating element;
a first cooling element; and
a first nip roller configured to compress a first fabric layer, a first polymer layer, and a first fiber layer together, wherein said first nip roller is disposed between said first heating element and said first cooling element along a path of said conveyor assembly.

2. The system of claim 1 further wherein said conveyor assembly comprises a main drive motor and at least one main drive roller.

3. The system of claim 2 further comprising a first constituent material distribution element.

4. The system of claim 3 wherein said first constituent material distribution element is a chopper unit.

5. The system of claim 3 further comprising a second constituent material distribution element.

6. The system of claim 5 wherein said second constituent material distribution element is a powder coating unit.

7. The system of claim 5 further comprising a length control element configured to cut said laminate base at a predetermined length.

8. The system of claim 7 further comprising:
a second heating element disposed between said first nip roller and said first cooling element;
a second nip roller disposed between said second heating element and said first cooling element, wherein said second nip roller is configured to compress said first fabric layer, said first polymer layer, and said first fiber layer together; and
a second cooling element, wherein said second heating element, said second nip roller, and said second cooling element are arranged along said path.

9. The system of claim 8 wherein said first cooling element is configured to cool said laminate base to a first temperature, wherein said second cooling element is configured to cool said laminate to a second temperature, and wherein said first temperature is higher than said second temperature.

10. The system of claim 9 wherein said first heating element and said second heating element are each configured to heat said laminate base to a third temperature to melt said polymer layer.
